(19) United States
(12) Patent Application Publication
(10) Pub. No.: US 2026/0296044 A1
(43) Pub. Date: Oct. 1, 2026

(54) PRINTING APPARATUS

(71) Applicant: CANON KABUSHIKI KAISHA, Tokyo (JP)

(72) Inventors: HIROMASA YONEYAMA, Kanagawa (JP); MASAKAZU NAGASHIMA, Kanagawa (JP); TAKUYA HANE, Kanagawa (JP); KENTA IIMURA, Tokyo (JP); KOHEI FUKUI, Tokyo (JP); SHU KURIHARA, Tokyo (JP); SHIN GENTA, Kanagawa (JP); AKIHIRO TOMIDA, Kanagawa (JP)

(21) Appl. No.: 19/630,190

(22) Filed: Mar. 26, 2026

(30) Foreign Application Priority Data
Mar. 28, 2025 (JP) 2025-055951

(51) Int. Cl. B41J 2/175

(52) U.S. Cl. CPC B41J 2/17596

(57) ABSTRACT

A printing apparatus includes a printing head, a liquid channel for supplying a liquid to the printing head, a conduit section provided in the liquid channel, and a pump for sending the liquid through the conduit section. The conduit section includes an inlet pipe for introducing the liquid, an expanded pipe through which the liquid from the inlet pipe flows, an outlet pipe through which the liquid flows out to the liquid channel, and a partition dividing an internal space of the expanded pipe along an extending direction of the expanded pipe. A cross-section area of the internal space of the expanded pipe is larger than a cross-section area of an internal space of the inlet pipe and a cross-section area of an internal space of the outlet pipe, and the partition has a through-hole portion penetrating the partition and protruding toward an upstream side of the expanded pipe.

This application claims the benefit of Japanese Patent Application No. 2025-055951, filed Mar. 28, 2025, which is hereby incorporated by reference herein in its entirety.

### BACKGROUND

### Field of the Technology

The present disclosure relates to a printing apparatus.

### Description of the Related Art

Inkjet printing apparatuses print images by ejecting a liquid such as ink onto a printing medium. Some inkjet printing apparatuses include a printing head configured to eject ink, a tank for storing the ink, and a pump for circulating the ink between the printing head and the tank. In such a printing apparatus, upon circulation of the ink by the pump, the fluid (ink) moves in a pulse-like manner, that is, pulsation occurs as the pump sends the ink to the printing head or tank. The pulsation occurs as a piston inside the pump reciprocally moves, thereby alternately repeating the suction and ejection of the fluid. Once the pulsation occurs, waves caused by the pulsation propagate inside the printing head. Therefore, in a case of printing an image by the printing head, the waves caused by the pulsation cause image unevenness and the like, affecting image quality. To keep the pulsation within a predetermined range, there has been devised a technology disclosed in Japanese Patent Laid-Open No. 4-250285 (Document 1).

In Document 1, a perforated plate with a large number of through-holes is disposed inside an expanded pipe connected to an inlet pipe and an outlet pipe. The cross-section area of an internal space of the expanded pipe is larger than the cross-section areas of internal spaces of the inlet and outlet pipes. The cross-section area of each through-hole is smaller than the cross-section area of the internal space of the expanded pipe. According to the technology disclosed in Document 1, the pulsation can be reduced by attenuating the pulsation as ink flowing into the expanded pipe from the inlet pipe passes through the large number of through-holes.

However, with the technology disclosed in Document 1, a flow that entrains ink around the through-holes is generated as the ink flowing into the expanded pipe passes through the through-holes. Hereinafter, the ink flow passing through the through-holes is referred to as a “main stream", while the flow that entrains the ink around the through-holes is referred to as a “tributary". If the tributary around the through-hole interferes with the main stream passing through the through-hole, turbulence occurs in the main stream passing through the through-hole, potentially increasing the pulsation of the ink (liquid) sent to the printing head.

### SUMMARY

The present disclosure is directed to a printing apparatus capable of suppressing pulsation of a liquid supplied to a printing head.

A printing apparatus according to an aspect of the present disclosure includes: a printing head configured to eject a liquid to print an image; a liquid channel for supplying the liquid to the printing head; a conduit section provided in the liquid channel; a pump configured to send the liquid in the liquid channel through the conduit section. The conduit section includes an inlet pipe for introducing the liquid flowing through the liquid channel, an expanded pipe connected to a downstream side of the inlet pipe and through which the liquid flowing in from the inlet pipe flows, an outlet pipe connected to a downstream side of the expanded pipe and through which the liquid flowing through the expanded pipe flows out to the liquid channel, and a partition dividing an internal space of the expanded pipe along an extending direction of the expanded pipe. A cross-section area of the internal space of the expanded pipe is larger than a cross-section area of an internal space of the inlet pipe and a cross-section area of an internal space of the outlet pipe, and the partition has a through-hole portion penetrating the partition and protruding toward an upstream side of the expanded pipe.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic diagram showing an example of an overall configuration of a printing apparatus;

FIG. 2 is a perspective view showing an example of a printing head;

FIG. 3 is a schematic diagram showing a circulation liquid channel;

FIG. 4 is a schematic diagram showing a liquid circulation path inside the printing head;

FIG. 5 is a block diagram showing a control unit;

FIG. 6 is a flowchart showing a flow of an ink filling operation;

FIG. 7 is an explanatory diagram showing a state where ink is filled up to a first pump and a second pump;

FIG. 8 is an explanatory diagram showing a state where ink is filled up to a part of a supply channel past a choke valve;

FIG. 9 is an explanatory diagram showing a state where ink is filled up to a supply-side air communicating channel from the supply channel;

FIG. 10 is an explanatory diagram showing a state where the ink is filled in the supply channel and the printing head;

FIGS. 11A and 11B are schematic diagrams showing an example of a pump;

FIG. 12 is an exploded view of a conduit section;

FIG. 13 is a sectional side view of the conduit section;

FIG. 14 is an explanatory diagram for explaining a flow of air inside the conduit section;

FIG. 15 is an explanatory diagram for explaining the precipitation of ink components inside the conduit section;

FIG. 16 is an explanatory diagram for explaining the precipitation of ink components inside the conduit section;

FIG. 17 is a side view of a holding unit;

FIG. 18 is a schematic diagram showing a state where the conduit section is located away from the pump;

FIG. 19 is a schematic diagram showing a state where the conduit section is located near the pump;

FIGS. 20A and 20B are explanatory diagrams showing the effect of the positioning of the conduit section on pulsation;

FIGS. 21A to 21E are schematic diagrams showing a flow of ink sent from two pumps in opposite phases;

FIG. 22 is a perspective view showing part of a holding member;

FIG. 23 is a perspective view of the conduit section fixed to the holding member, as seen from the front side;

FIG. 24 is a perspective view of the conduit section fixed to the holding member, as seen from the back side;

FIG. 25 is an explanatory diagram showing a positional relationship between the conduit section and a fixing member;

FIGS. 26A and 26B are side views showing the conduit section fixed by the fixing member;

FIG. 27 is a schematic diagram showing a circulation liquid channel of a third embodiment;

FIG. 28 is a sectional side view of a conduit section;

FIG. 29 is a side view of a supply-side conduit section and a collection-side conduit section;

FIG. 30 is a sectional side view for explaining the inclination of the conduit section;

FIG. 31 is a schematic diagram showing a conduit section of a modification;

FIG. 32 is an explanatory diagram for explaining a flow of air inside the conduit section of the modification;

FIG. 33 is a side view of a supply-side conduit section and a collection-side conduit section of the modification; and

FIG. 34 is a side view of a supply-side conduit section and a collection-side conduit section of another modification.

### DESCRIPTION OF THE EMBODIMENTS

Preferred embodiments of the present disclosure will be described in detail below with reference to the attached drawings. Note that the following embodiments do not limit the scope of the present disclosure, and not all combinations of features described in the following embodiments are necessarily essential to the solutions of the present disclosure. Note that the same parts will be denoted by the same reference numerals. In addition, in the present disclosure, the term “central portion" of a member refers to a region within 20 % of the distance from the center to the edge of the member. For example, the expression “the lower through-hole portion 645 is located in the central portion of the lower partition 641" described below means that the lower through-hole portion 645 is located in a region within 20 % of the distance from the center of the lower partition 641 to the edge of the lower partition 641.

### First Embodiment

### Overall Configuration of Printing Apparatus

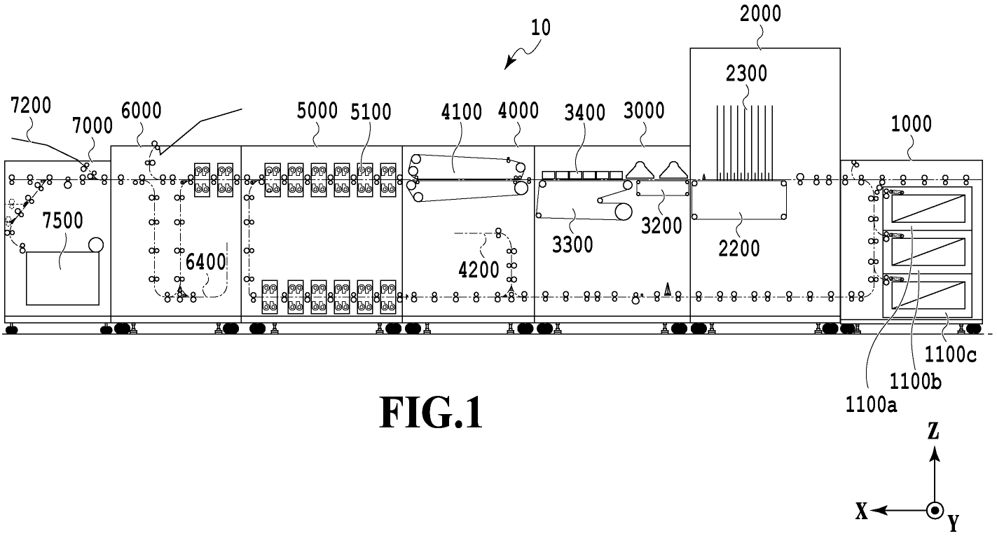

An overall configuration of a printing apparatus 10 in the present embodiment will be described below with reference to the drawings. In each drawing, arrows X and Y indicate horizontal directions orthogonal to each other, and an arrow Z indicates a vertical direction. The X direction is generally a conveyance direction in which a sheet S as a printing medium is conveyed inside the printing apparatus 10, and specifically corresponds to a conveyance direction in which the sheet S is conveyed in a printing unit 2300. In FIG. 1, the top of the apparatus is defined as the upper side and the right-to-left direction as a longitudinal direction. In addition, the front-to-back direction of the page space orthogonal to the sheet conveyance direction is defined as a sheet width direction. The front side of the page space is the front side of the apparatus, and the back side of the page space is the rear side of the apparatus.

FIG. 1 is a schematic diagram showing an example of an overall configuration of the printing apparatus 10. The printing apparatus 10 is a sheet-fed printing apparatus for producing a printed product by forming an ink image (image) on the sheet S using two types of liquids, a reaction liquid and ink. The printing apparatus 10 of the present embodiment includes a sheet feed module 1000, a print module 2000, a drying module 3000, a fixing module 4000, a cooling module 5000, an inversion module 6000, and a discharge stacking module 7000. The cut sheet S supplied from the sheet feed module 1000 is conveyed along a conveyance path, processed in each module, and discharged to the discharge stacking module 7000.

The sheet feed module 1000 is equipped with three storage containers 1100a to 1100c for accommodating the sheets S. The storage containers 1100a to 1100c can each be pulled out toward the apparatus front side (front side of the page space). The sheets S are fed one by one by a separation belt and conveyance rollers in each of the storage containers 1100a to 1100c, and then conveyed to the print module 2000. The number of the storage containers 1100a to 1100c is not limited to three, but the configuration may include one, two, or four or more storage containers.

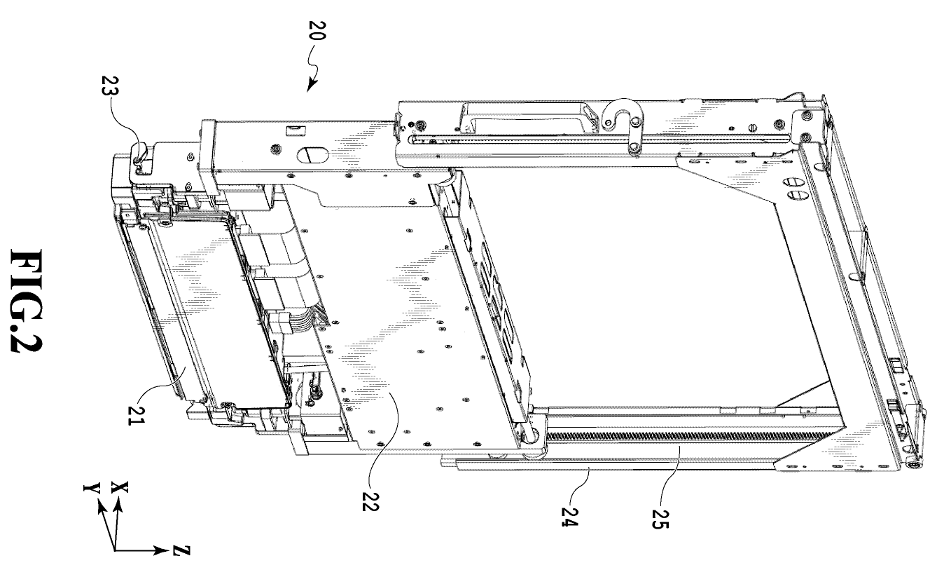

The print module 2000 includes a pre-imaging registration correction unit (not shown), a print belt unit 2200, and the printing unit 2300. The pre-imaging registration correction unit corrects the tilt and position of the sheet S conveyed from the sheet feed module 1000, and the sheet S is then conveyed to the print belt unit 2200. The printing unit 2300 is disposed facing the print belt unit 2200 along the conveyance path of the sheet S. The printing unit 2300 performs a printing process (print processing) on the conveyed sheet S from above using a printing head 21 (see FIG. 2) to form an image on the sheet S. The sheet S is sucked and conveyed by the print belt unit 2200, ensuring clearance with the printing head 21. A plurality of the printing heads 21 are arranged in the conveyance direction (X direction).

FIG. 2 is a perspective view showing an example of the printing head 21. The printing unit 2300 of the present embodiment has the plurality of printing heads 21, and FIG. 2 shows one of the printing heads 21. As shown in FIG. 2, the printing head 21 has a printing head supporting shaft 23. The printing head 21 is pivotally supported by a printing head holding portion 22 for vertically elevating and lowering the printing head 21 while holding the printing head 21, such that the printing head holding portion 22 supports the printing head supporting shaft 23 from below. The printing head holding portion 22 is elevated and lowered vertically (in the Z direction) along elevating and lowering rails 25 provided in a printing head elevating and lowering frame 24 by a drive mechanism (not shown) that serves as a head moving unit provided internally. Hereinafter, the printing head 21 and the printing head holding portion 22 will be collectively referred to as a head unit 20.

A lowered position of the head unit 20 is a printing position where the printing head 21 performs printing. An elevated position of the head unit 20 higher than the printing position is a retracted position where the printing head 21 is retracted. Between the printing position and the retracted position, there is a maintenance position for performing maintenance of the printing head 21. In the present embodiment, the head unit 20 is configured to be movable to the three positions, but may be configured to be movable to two or more positions. For example, the retracted position and the maintenance position may be the same position.

Continuing with the description of FIG. 1, the printing unit 2300 of the present embodiment has a total of five line-type printing heads 21 corresponding to four colors of Y (yellow), M (magenta), C (cyan), and Bk (black), as well as a reaction liquid. Note that the number of colors and the number of printing heads are not limited to five. As an inkjet method, a method using heating elements, a method using piezoelectric elements, a method using electrostatic elements, a method using MEMS elements, or the like can be adopted. Ink of each color is supplied to the printing head 21 from an ink tank (not shown) through an ink tube.

The sheet S printed in the printing unit 2300 is conveyed by the print belt unit 2200. An in-line scanner (not shown) disposed downstream of the printing unit 2300 in the conveyance direction detects misalignment and color density of the image formed on the sheet S, allowing the printed image to be corrected.

The drying module 3000 includes a decoupling unit 3200, a drying belt unit 3300, and a hot air blowing unit 3400. The drying module 3000 reduces liquid components contained in the ink applied onto the sheet S in the printing unit 2300 to improve fixability of the sheet S and the ink. The sheet S printed in the printing unit 2300 of the print module 2000 is conveyed to the decoupling unit 3200 disposed inside the drying module 3000. The decoupling unit 3200 can convey the sheet S by using air pressure from above and belt friction. By loosely holding and conveying the sheet S on the belt, misalignment of the sheet S can be reduced on the print belt unit 2200 where an ink image is formed. The sheet S conveyed from the decoupling unit 3200 is sucked and conveyed by the drying belt unit 3300, while hot air is blown onto the sheet from the hot air blowing unit 3400 disposed above the belt. Accordingly, the ink-applied surface of the sheet S is dried. Besides the method of blowing hot air, the drying method may also be combined with a method of irradiating the surface of the sheet S with electromagnetic waves (such as ultraviolet or infrared rays) or a conductive heat transfer method using contact with a heating element. To improve drying efficiency, the above method may also be used to apply heat to the surface of the sheet S opposite to the ink-applied surface.

The fixing module 4000 has a fixing belt unit 4100. The fixing belt unit 4100 has an upper belt unit and a lower belt unit. By passing the sheet S conveyed from the drying module 3000 between the heated upper and lower belt units, the ink can be fixed to the sheet S.

The cooling module 5000 has a plurality of cooling units 5100. The cooling units 5100 cool the hot sheet S conveyed from the fixing module 4000. The cooling units 5100 use a fan to draw outside air into a cooling box, increasing the pressure inside the cooling box, and cool the sheet S by blowing air pouring forth from nozzles formed in a conveyance guide against the sheet S. The cooling units 5100 are disposed on both sides of the conveyance path, and capable of cooling the sheet S from both sides. The cooling module 5000 also includes a conveyance path switching unit capable of switching the conveyance path of the sheet S, depending on whether the sheet S is conveyed to the inversion module 6000 or to a duplex conveyance path used for duplex printing. During the duplex printing, the sheet S is conveyed to the conveyance path below the cooling module 5000 and further conveyed along the duplex conveyance path of the fixing module 4000, drying module 3000, print module 2000, and sheet feed module 1000. The sheet S is then conveyed again to the pre-imaging registration correction unit, the print belt unit 2200, and the printing unit 2300 in the print module 2000, and the printing unit 2300 performs printing. A duplex conveyance unit of the fixing module 4000 is provided with an inversion unit 4200 configured to invert the sheet S.

The inversion module 6000 includes an inversion unit 6400. The inversion module 6000 can invert the conveyed sheet S, using the inversion unit 6400, and freely switch between two sides of the sheet S to be discharged.

The discharge stacking module 7000 has a top tray 7200 and a stacking unit 7500, and aligns and stacks the sheets S conveyed from the inversion module 6000.

### Configuration of Circulation Unit

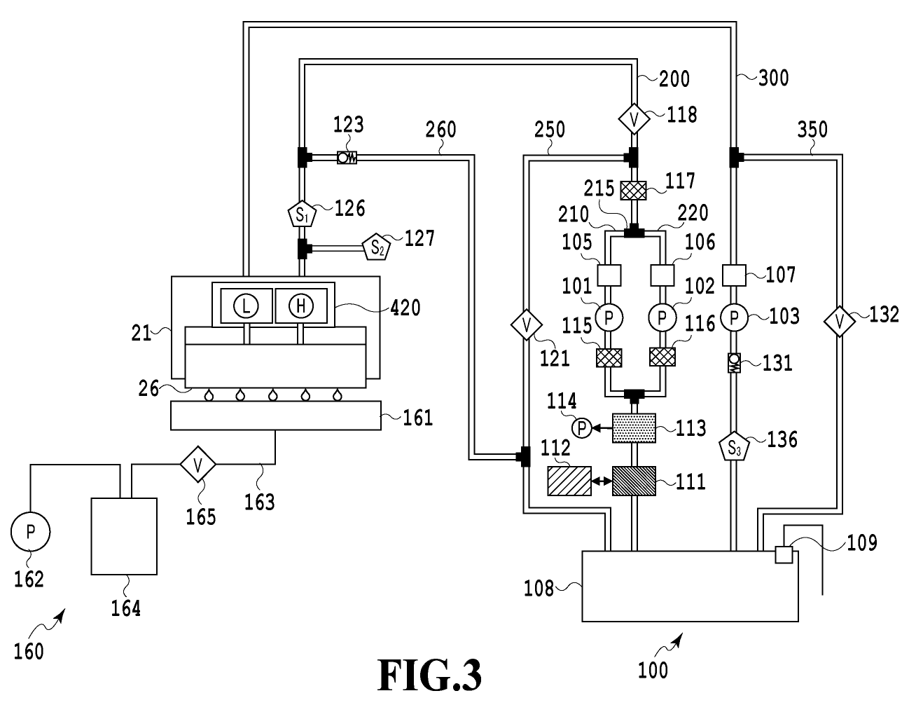

FIG. 3 is a schematic diagram showing a circulation liquid channel including a circulation unit 100 for supplying ink to the printing head 21. Note that the following description is given of a printing head configured to eject ink as an example, but the same applies to a printing head configured to eject a liquid such as a reaction liquid. The circulation unit 100 of the present embodiment includes a first pump 101, a second pump 102, a third pump 103, a first conduit section 105, a second conduit section 106, a third conduit section 107, and a buffer tank 108. The circulation unit 100 also includes a heat exchanger 111, a deaeration module 113, a first filter 115, a second filter 116, a third filter 117, and a choke valve 118. The circulation unit 100 also includes a first solenoid valve 121, a relief valve 123, a check valve 131, and a second solenoid valve 132. The components of the circulation unit 100 may be connected directly or through resin or metal piping.

The buffer tank 108 is a reservoir for storing ink supplied from an ink tank (not shown). A supply channel 200 is connected to the buffer tank 108 to supply ink to the printing head 21. A first branching flow passage 210 and a second branching flow passage 220 are formed in part of the supply channel 200 and configured to branch off and merge midway through the supply channel 200. A collecting channel 300 is also connected to the buffer tank 108 to collect ink not ejected from ejection ports of the printing head 21. A supply-side air communicating channel 250 and a relief channel 260 branched off from the supply channel 200 are connected to the buffer tank 108. A collection-side air communicating channel 350 branched off from the collecting channel 300 is connected to the buffer tank 108.

The supply channel 200, the supply-side air communicating channel 250, the relief channel 260, the collecting channel 300, and the collection-side air communicating channel 350 form a circulation liquid channel for supplying and circulating ink to the printing head 21. The buffer tank 108 is also provided with an air communicating port 109 for stabilizing the pressure inside the circulation liquid channel. The inside of the buffer tank 108 is communicated with the outside air through the air communicating port 109. The buffer tank 108 is provided with a weight sensor (not shown) to detect the weight of the buffer tank 108.

In the supply channel 200, the heat exchanger 111, the deaeration module 113, the first branching flow passage 210, the second branching flow passage 220, the third filter 117, and the choke valve 118 are disposed in this order from the buffer tank 108 side. In the first branching flow passage 210, the first filter 115, the first pump 101, and the first conduit section 105 are disposed in this order from the buffer tank 108 side. In the second branching flow passage 220, the second filter 116, the second pump 102, and the second conduit section 106 are disposed in this order from the buffer tank 108 side.

The heat exchanger 111 is a temperature regulating unit configured to regulate the temperature of the ink, together with a temperature regulator 112. The heat exchanger 111 exchanges heat between the ink and a constant-temperature medium in the heat exchanger 111. The constant-temperature medium circulates between the heat exchanger 111 and the temperature regulator 112, and the temperature of the ink is regulated by the temperature regulator 112.

The deaeration module 113 is a deaeration unit for removing gas dissolved in the ink. The deaeration module 113 is connected to a pressure-reducing pump 114 disposed outside the circulation unit 100. A porous hollow fiber membrane is provided inside the deaeration module 113. The deaeration module 113 is capable of reducing the pressure inside the hollow fiber membrane by operating the pressure-reducing pump 114. As the ink flows into the deaeration module 113 with the pressure inside the hollow fiber membrane reduced by the pressure-reducing pump 114, the gas (dissolved oxygen) dissolved in the ink is sucked into the hollow fiber membrane and discharged to the outside by the pressure-reducing pump 114. This allows deaerated ink to be supplied to the printing head 21.

The first filter 115 has a function to filter ink containing foreign matter of about several μm in size in the first branching flow passage 210. The first filter 115 captures sticking matter formed in the first branching flow passage 210 and foreign matter mixed into the ink, thereby suppressing the sticking matter and foreign matter from being mixed into the printing head 21. The second filter 116 has a function to filter ink containing foreign matter of about several μm in size in the second branching flow passage 220. The second filter 116 captures sticking matter in the second branching flow passage 220 and foreign matter mixed into the ink, thereby suppressing the sticking matter and foreign matter from being mixed into the printing head 21.

The first pump 101 sends the ink stored in the buffer tank 108 to the printing head 21 through the first conduit section 105 disposed in the supply channel 200 (first branching flow passage 210). The second pump 102 sends the ink stored in the buffer tank 108 to the printing head 21 through the second conduit section 106 disposed in the supply channel 200 (second branching flow passage 220). The first pump 101 and the second pump 102 are configured using diaphragm pumps, for example. The second pump 102 is provided in a case where it is difficult to send a sufficient amount of ink from the buffer tank 108 to the printing head 21 using only the first pump 101. The second branching flow passage 220 including the second pump 102 and the like does not need to be provided if a sufficient amount of ink can be sent from the buffer tank 108 to the printing head 21 using only the first pump 101.

The cross-section area of the internal space of the first conduit section 105 is larger than the cross-section area of the first branching flow passage 210. This allows the first conduit section 105 to reduce pulsation generated as the first pump 101 sends the ink. The cross-section area of the internal space of the second conduit section 106 is larger than the cross-section area of the second branching flow passage 220. This allows the second conduit section 106 to reduce pulsation generated as the second pump 102 sends the ink. The second conduit section 106 and the second filter 116 do not need to be provided if the second pump 102 is not provided. In the present embodiment, the cross sections and cross-section areas of the internal spaces of the first conduit section 105, the second conduit section 106, and the like are those in a direction intersecting (in the present embodiment, orthogonal to) the extending direction of the first conduit section 105, the second conduit section 106, and the like.

The third filter 117 has a function to filter ink containing foreign matter of about several μm in size in a flow path between the choke valve 118 and the first and second branching flow passages 210 and 220 in the supply channel 200. The third filter 117 captures sticking matter, foreign matter and the like that are not captured by the first filter 115 and the second filter 116, thereby suppressing the sticking matter and foreign matter from being mixed into the printing head 21. The third filter 117 may be a filter having a pore size different from those of the first filter 115 and the second filter 116.

The choke valve 118 is a solenoid valve for applying negative pressure to the printing head 21 and the circulation liquid channel through a cap 161 of a recovery unit 160 as the ink is filled in the printing head 21 and the circulation liquid channel. The choke valve 118 is disposed in a portion of the supply channel 200 between the printing head 21 and the first and second conduit sections 105 and 106 (a junction 215 between the first branching flow passage 210 and the second branching flow passage 220). A temperature sensor 126 and a pressure sensor 127 are also disposed in a portion of the supply channel 200 between the choke valve 118 and the printing head 21.

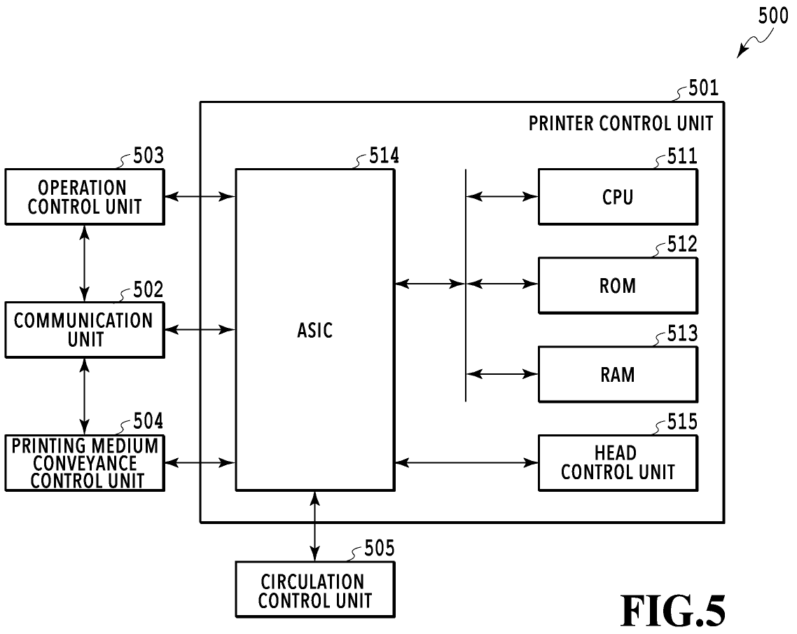

The temperature sensor 126 is a sensor for monitoring the temperature of the ink supplied to the printing head 21 by a printer control unit 501 (see FIG. 5 described below) or the like. For example, if a temperature value detected by the temperature sensor 126 falls outside a predetermined temperature range, the printer control unit 501 performs control to warn a user to change the temperature setting of the temperature regulator 112.

The pressure sensor 127 is a sensor for monitoring the pressure applied to the printing head 21 from the supply channel 200 by a circulation control unit 505 (see FIG. 5 described below). The circulation control unit 505 performs control to change a drive frequency of the first pump 101 or the second pump 102 by sending a control signal to the first pump 101 or the second pump 102, so that the pressure value detected by the pressure sensor 127 falls within a predetermined pressure range. If the pressure value detected by the pressure sensor 127 falls outside the predetermined pressure range even after the drive frequency is changed, the circulation control unit 505 detects an abnormality in the supply channel 200 and controls the circulation unit 100 to stop circulating the ink.

The supply-side air communicating channel 250 is a channel for releasing the pressure inside the supply channel 200 to atmospheric pressure as the ink circulation stops. The supply-side air communicating channel 250 branches off from a portion of the supply channel 200 between the third filter 117 (the junction 215 between the first branching flow passage 210 and the second branching flow passage 220) and the choke valve 118, and is connected to the buffer tank 108. The first solenoid valve 121 is disposed in the supply-side air communicating channel 250. The pressure inside the supply channel 200 is released to the atmospheric pressure through the supply-side air communicating channel 250, the buffer tank 108, and the air communicating port 109 by the first solenoid valve 121 opening the supply-side air communicating channel 250 as the ink circulation stops.

The relief channel 260 is a channel for releasing excess pressure applied to the printing head 21. The relief channel 260 branches off from a portion of the supply channel 200 between the choke valve 118 and the printing head 21 (temperature sensor 126) and is connected to the buffer tank 108. The relief valve 123 is disposed in the relief channel 260. If the pressure inside the relief channel 260 is below a predetermined pressure, the relief valve 123 closes the relief channel 260. If the pressure inside the relief channel 260 is greater than or equal to the predetermined pressure, the relief valve 123 opens the relief channel 260. Accordingly, the excess pressure applied to the printing head 21 from the supply channel 200 is released to the outside through the relief channel 260, the buffer tank 108, and the air communicating port 109.

In the collecting channel 300, the third conduit section 107, the third pump 103, and the check valve 131 are disposed in this order from the printing head 21 side. The cross-section area of the internal space of the third conduit section 107 is larger than the cross-section area of the collecting channel 300. This allows the third conduit section 107 to reduce pulsation of ink discharged from the printing head 21.

The third pump 103 sends the ink discharged from the printing head 21 to the buffer tank 108 through the third conduit section 107 disposed in the collecting channel 300. The third pump 103 is configured using a diaphragm pump, for example.

The check valve 131 restricts the flow of ink from the buffer tank 108 toward the printing head 21, while allowing ink to flow from the printing head 21 toward the buffer tank 108. This allows the check valve 131 to suppress ink backflow in the collecting channel 300 as the ink is filled in the printing head 21 and the circulation liquid channel. Therefore, if the negative pressure applied to the printing head 21 and the circulation liquid channel through the cap 161 becomes too strong as the ink is filled in the printing head 21 and the circulation liquid channel, the ink can be suppressed from flowing into the printing head 21 from the collecting channel 300. A flow rate sensor 136 is also disposed between the check valve 131 and the buffer tank 108 in the collecting channel 300.

The flow rate sensor 136 is a sensor for monitoring the flow rate of ink flowing through the collecting channel 300 (circulation liquid channel) by the circulation control unit 505 as the ink circulates through the circulation liquid channel. The circulation control unit 505 performs control to change a drive frequency of the third pump 103 by sending a control signal to the third pump 103, so that the flow rate value detected by the flow rate sensor 136 falls within a predetermined flow rate range. If the flow rate value detected by the flow rate sensor 136 falls outside the predetermined flow rate range even after the drive frequency is changed, the circulation control unit 505 detects an abnormality in the collecting channel 300 and controls the circulation unit 100 to stop circulating the ink.

The collection-side air communicating channel 350 is a channel for releasing the pressure inside the collecting channel 300 to atmospheric pressure as the ink circulation stops. The collection-side air communicating channel 350 branches off from a portion of the collecting channel 300 between the printing head 21 and the third conduit section 107, and is connected to the buffer tank 108. The second solenoid valve 132 is disposed in the collection-side air communicating channel 350. The pressure inside the collecting channel 300 is released to the atmospheric pressure through the collection-side air communicating channel 350, the buffer tank 108, and the air communicating port 109 by the second solenoid valve 132 opening the collection-side air communicating channel 350 as the ink circulation stops.

The configuration of the circulation unit 100 is not limited to that described in the present embodiment. For example, the circulation unit 100 does not have to have a filter or a check valve. Furthermore, the circulation unit 100 does not have to have a temperature sensor.

The recovery unit 160 includes the cap 161, a suction pump 162, a suction pipe 163, a waste liquid tank 164, and a suction solenoid valve 165. The cap 161 caps (covers) an ejection surface 26 formed in the lower part of the printing head 21 in a state where the printing head 21 is located in the maintenance position. The ejection surface 26 of the printing head 21 has a plurality of ejection ports (not shown) formed therein for ejecting ink from the printing head 21. The suction pump 162 sucks ink inside the cap 161 through the suction pipe 163 and the waste liquid tank 164. The suction pipe 163 connects the cap 161 to the waste liquid tank 164. The waste liquid tank 164 stores waste ink sucked by the suction pump 162. The suction solenoid valve 165 is disposed in the suction pipe 163 and capable of opening and closing the flow path inside the suction pipe 163. For example, with the cap 161 capping the ejection surface 26 of the printing head 21, the suction solenoid valve 165 opens the flow path inside the suction pipe 163, causing the suction pump 162 to suck the inside of the printing head 21 through the cap 161. This makes it possible to remove air bubbles remaining inside the printing head 21 and ink with increased viscosity near the ejection ports of the printing head 21. The recovery unit 160 also functions as a negative pressure imparting unit configured to impart negative pressure in the circulation liquid channel through the printing head 21 as the ink is filled in the printing head 21 and the circulation liquid channel.

### Liquid Circulation Path Inside Printing Head

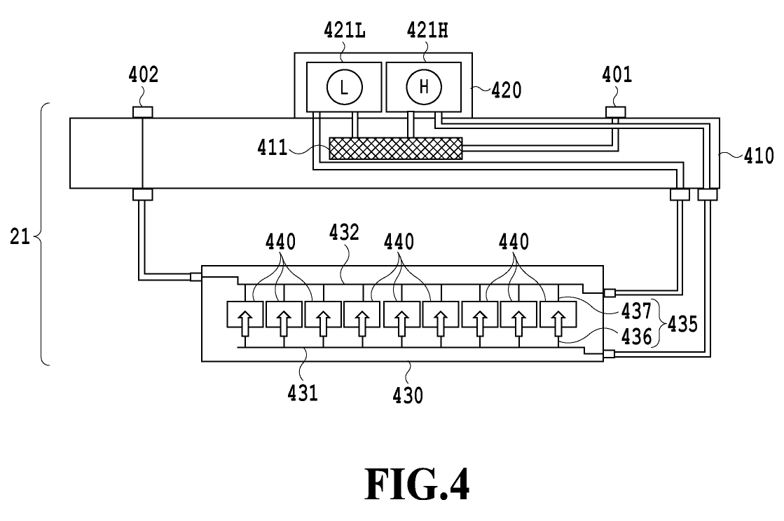

FIG. 4 is a schematic diagram showing the liquid circulation path inside the printing head 21 in the present embodiment. The printing head 21 includes a liquid supply unit 410, a negative pressure control unit 420, and a liquid ejection unit 430, all of which are provided inside the printing head 21. The liquid supply unit 410 is connected to the supply channel 200 through a supply-side connection part 401. The liquid supply unit 410 is also connected to the liquid ejection unit 430 through the negative pressure control unit 420. The liquid ejection unit 430 is connected to the collecting channel 300 through a collection-side connection part 402.

The ink stored in the buffer tank 108 of the circulation unit 100 is supplied from the supply channel 200 to the liquid supply unit 410 of the printing head 21 through the supply-side connection part 401 by the first pump 101 and the second pump 102. After being supplied to the liquid supply unit 410, the ink is adjusted to two different negative pressures (high pressure and low pressure) by the negative pressure control unit 420. The ink then splits into two flow paths, high-pressure side and low-pressure side, and reaches the liquid ejection unit 430. The ink supplied to the inside of the printing head 21 is circulated inside the printing head 21 through the liquid supply unit 410, the negative pressure control unit 420, and the liquid ejection unit 430 by the third pump 103 of the circulation unit 100. The ink circulated inside the printing head 21 is discharged from the liquid ejection unit 430 to the collecting channel 300 through the collection-side connection part 402, and is collected in the buffer tank 108. In this case, the third pump 103 draws the ink inside the printing head 21 from the collection-side connection part 402 and sends the ink to the buffer tank 108.

As described above, the first pump 101 and the second pump 102 are configured using diaphragm pumps, for example. The first pump 101 and the second pump 102 may be any pump with a head pressure greater than or equal to a given pressure within the range of the ink circulation flow rate used as the printing head 21 is operated. The first pump 101 and the second pump 102 may be a turbo pump, a positive-displacement pump, or the like. For example, instead of the diaphragm pumps, a head tank disposed with a certain water head difference relative to the negative pressure control unit 420 may be used as the first pump 101 and the second pump 102.

As described above, the third pump 103 is configured using a diaphragm pump, for example. It is preferable to use a positive-displacement pump with a quantitative liquid feeding capacity as the third pump 103. The third pump 103 may also be configured to ensure a constant flow rate by having a general constant flow rate valve or relief valve at the pump outlet. As the printing head 21 is operated, the third pump 103 is operated to cause the ink to flow at a predetermined flow rate through a common supply channel 431 and a common collecting channel 432 of the liquid ejection unit 430. Such an ink flow at the predetermined flow rate allows the temperature inside the printing head 21 to be maintained at an optimum temperature. The predetermined flow rate of the ink is preferably set to be higher than or equal to a flow rate at which a temperature difference between a plurality of printing element substrates 440 in the liquid ejection unit 430 does not affect image quality. However, if the predetermined ink flow rate is too high, the negative pressure difference between the plurality of printing element substrates 440 is increased by the influence of pressure loss in the flow path inside the liquid ejection unit 430, resulting in uneven density in an image printed using the plurality of printing element substrates 440. For this reason, it is preferable to set the predetermined flow rate of ink, taking into consideration the temperature difference and negative pressure difference between the plurality of printing element substrates 440.

The negative pressure control unit 420 is disposed in a flow path between the first and second conduit sections 105 and 106 of the circulation unit 100 and the liquid ejection unit 430. The flow rate of the ink circulating inside the printing head 21 can fluctuate due to a difference in ejection volume per unit area. Even if the flow rate of ink circulating inside the printing head 21 fluctuates, the negative pressure control unit 420 operates to maintain the pressure in the flow path downstream of the negative pressure control unit 420 (on the liquid ejection unit 430 side) at a preset constant pressure. The negative pressure control unit 420 has two pressure regulating mechanisms 421H and 421L on the high-pressure side (H) and on the low-pressure side (L). The two pressure regulating mechanisms 421H and 421L may be any mechanism capable of controlling the pressure in the flow path downstream of the negative pressure control unit 420 within a given range of fluctuations centered on a desired set pressure. The two pressure regulating mechanisms 421H and 421L may be, for example, mechanisms similar to so-called “pressure-reducing regulators”. In the present embodiment, the first pump 101 and the second pump 102 pressurize the upstream side of the negative pressure control unit 420 through the liquid supply unit 410. This makes it possible to reduce the influence of the water head difference in the buffer tank 108 on the printing head 21, thereby increasing the degree of freedom of layout of the buffer tank 108 in the printing apparatus.

The two pressure regulating mechanisms 421H and 421L are set to have different control pressures. The control pressure of the high-pressure side (H) pressure regulating mechanism 421H is set to a relatively high pressure. The control pressure of the low-pressure side (L) pressure regulating mechanism 421L is set to a relatively low pressure. The upstream side of the two pressure regulating mechanisms 421H and 421L is connected to a flow path from the supply-side connection part 401 through a filter 411 provided in the liquid supply unit 410. The downstream side of the high-pressure side (H) pressure regulating mechanism 421H is connected to the common supply channel 431 of the liquid ejection unit 430 through the inside of the liquid supply unit 410. The downstream side of the low-pressure side (L) pressure regulating mechanism 421L is connected to the common collecting channel 432 of the liquid ejection unit 430 through the inside of the liquid supply unit 410.

The liquid ejection unit 430 has the common supply channel 431, the common collecting channel 432, a plurality of individual channels 435, and the plurality of printing element substrates 440. The plurality of individual channels 435 are provided corresponding to the plurality of printing element substrates 440. The plurality of individual channels 435 are communicated with the common supply channel 431 and the common collecting channel 432. Each of the printing element substrates 440 is disposed in each of the individual channels 435. The individual channel 435 has an individual supply channel 436 and an individual collecting channel 437. The individual supply channel 436 is communicated with the common supply channel 431 and the printing element substrate 440. The individual collecting channel 437 is communicated with the printing element substrate 440 and the common collecting channel 432. The downstream side of the common collecting channel 432 is connected to the collecting channel 300 through the collection-side connection part 402. The printing element substrate 440 has a pressure chamber (not shown), a printing element (not shown), and the like for ejecting ink from an ejection port (not shown).

The high-pressure side (H) pressure regulating mechanism 421H is connected to the common supply channel 431, and the low-pressure side (L) pressure regulating mechanism 421L is connected to the common collecting channel 432, creating a negative pressure difference (pressure difference) between the common supply channel 431 and the common collecting channel 432. The negative pressure difference between the common supply channel 431 and the common collecting channel 432 causes some of the ink flowing through the common supply channel 431 to pass through the individual supply channels 436 in the individual channels 435, the internal channels of the printing element substrates 440, and the individual collecting channels 437, and then flow into the common collecting channel 432.

In the liquid ejection unit 430, while ink from the negative pressure control unit 420 flows through the common supply channel 431 and the common collecting channel 432, some of the ink flowing through the common supply channel 431 passes through the internal channels of the printing element substrates 440. Therefore, heat generated in each printing element substrate 440 can be discharged to the outside of the printing head 21 (liquid ejection unit 430) by the ink flowing through the common supply channel 431 and the common collecting channel 432. Furthermore, upon printing of an image by the printing head 21, ink also flows through the ejection ports and pressure chambers of the printing element substrates 440 that do not eject ink. This makes it possible to reduce the ink viscosity increased inside the ejection ports, thus avoiding a situation where the ink cannot be normally ejected due to the increased viscosity near the ejection ports. Furthermore, ink with increased viscosity or foreign matter contained in the ink can be discharged from the printing element substrates 440 to the common collecting channel 432. This enables the printing head 21 of the present embodiment to print high-quality images at high speed.

### Configuration of Control Unit

FIG. 5 is a block diagram showing a control unit 500 of the printing apparatus 10. The control unit 500 includes a printer control unit 501, a communication unit 502, an operation control unit 503, a printing medium conveyance control unit 504, and a circulation control unit 505. The printer control unit 501 controls a printing process. The printer control unit 501 includes a central processing unit (CPU) 511, a read-only memory (ROM) 512, a random access memory (RAM) 513, an application specific integrated circuit (ASIC) 514, and a head control unit 515.

The CPU 511 controls the entire printing apparatus 10. The ROM 512 stores control programs executed by the CPU 511 and various data. The RAM 513 temporarily stores data processed by the CPU 511 and data received by the communication unit 502. The ASIC 514 includes a network controller, a serial IF controller, a head data generation controller, a motor controller, and the like. The head control unit 515 generates final ejection data for ejecting ink from the printing head 21, generates a drive voltage, controls the elevation and lowering of the printing head holding portion 22, and obtains the temperature of the printing head 21. The CPU 511, the ROM 512, and the RAM 513 are electrically connected to the ASIC 514. The ASIC 514 is electrically connected to the head control unit 515.

The communication unit 502 receives a print job containing print data sent from an external print server or personal computer (PC). The operation control unit 503 controls an operation panel (not shown) for receiving user input. The printing medium conveyance control unit 504 controls the conveyance of the printing medium. The circulation control unit 505 controls the operations of the first to third pumps 101 to 103, the first solenoid valve 121, the second solenoid valve 132, and the like in the circulation unit 100. The operation control unit 503, the printing medium conveyance control unit 504, and the circulation control unit 505 each include at least one processor and at least one storage device for storing programs executed by the processor. A semiconductor memory, for example, is used as the storage device. The communication unit 502, the operation control unit 503, the printing medium conveyance control unit 504, and the circulation control unit 505 are electrically connected to the ASIC 514 of the printer control unit 501.

### Ink Filling Operation

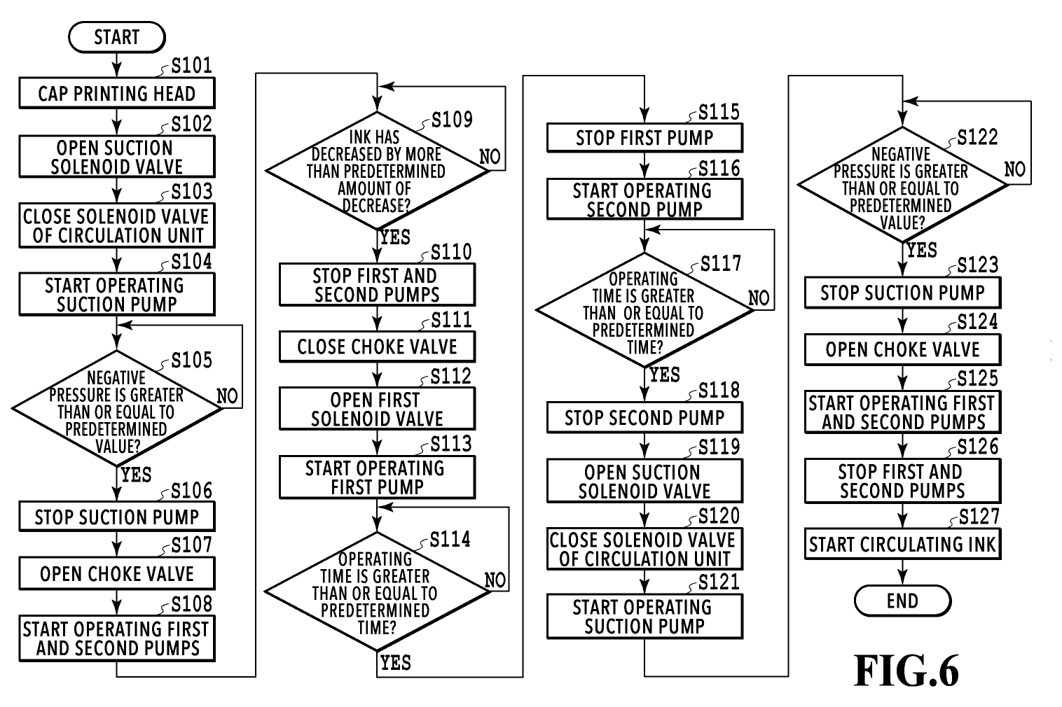

Next, description will be given of a filling operation for filling the printing head 21 and the circulation liquid channel with ink. FIG. 6 is a flowchart showing a flow of the ink filling operation. The ink filling operation is controlled by the printer control unit 501, the circulation control unit 505, and the like of the control unit 500.

First, in Step S101, the cap 161 of the recovery unit 160 caps the ejection surface 26 of the printing head 21. In this event, the printing head holding portion 22 and the like are operated to move the printing head 21 to the maintenance position above and near the cap 161. As the printing head 21 moves to the maintenance position, the cap 161 caps the ejection surface 26 of the printing head 21. In this event, the printing head 21 may approach the cap 161 for capping, or the cap 161 may approach the printing head 21 for capping.

In the next Step S102, the suction solenoid valve 165 of the recovery unit 160 opens the flow path in the suction pipe 163. With the cap 161 capping the ejection surface 26 of the printing head 21, the suction solenoid valve 165 opens the flow path in the suction pipe 163, thereby allowing the recovery unit 160 to apply negative pressure to the circulation liquid channel through the printing head 21.

In Step S103, the choke valve 118 and the first solenoid valve 121 of the circulation unit 100 close a part of the circulation liquid channel. In this case, the choke valve 118 closes the supply channel 200 in the circulation liquid channel. The first solenoid valve 121 closes the supply-side air communicating channel 250. Note that the order of Steps S102 and S103 may be reversed. Steps S102 and S103 may be performed in parallel. Furthermore, the second solenoid valve 132 may close or open the collection-side air communicating channel 350.

In the next Step S104, the suction pump 162 of the recovery unit 160 starts its operation. With the flow path in the suction pipe 163 opened by the suction solenoid valve 165, the operation of the suction pump 162 causes negative pressure to act on the circulation liquid channel (supply channel 200) through the printing head 21. The magnitude of the negative pressure acting on the supply channel 200 is detected by the pressure sensor 127.

In the next Step S105, the circulation control unit 505 determines whether the magnitude (pressure value) of the negative pressure detected by the pressure sensor 127 is greater than or equal to a predetermined value. If the pressure value detected by the pressure sensor 127 is less than the predetermined value, that is, if the determination result in Step S105 is NO, the processing of Step S105 is repeated. If the pressure value detected by the pressure sensor 127 is greater than or equal to the predetermined value, that is, if the determination result in Step S105 is YES, the processing proceeds to Step S106. If Step S105 is executed a predetermined number of times, or if the determination result is NO even after a predetermined time has elapsed since the start of Step S104, the CPU 511 executes processing to notify the user of an error due to a problem with the ink supply. For example, the CPU 511 displays the error on the operation panel.

In Step S106, the suction pump 162 of the recovery unit 160 stops. In this event, with the supply channel 200 closed by the choke valve 118 of the circulation unit 100, negative pressure acts on the printing head 21 and the circulation liquid channel (supply channel 200).

In the next Step, S107, the choke valve 118 opens the supply channel 200. This allows ink to flow from the buffer tank 108 to the supply channel 200 by using the negative pressure applied to the supply channel 200 through the printing head 21.

In the next Step S108, the first pump 101 and the second pump 102 of the circulation unit 100 start their operation. With the choke valve 118 opened and the first solenoid valve 121 closed, the operation of the first pump 101 and the second pump 102 fills the supply channel 200 with the ink stored in the buffer tank 108. In addition, the weight of the buffer tank 108 in which the ink is stored is detected by a weight sensor (not shown).

The operations of Steps S101 to S108 are also referred to as choke suction. With no ink in the circulation liquid channel (supply channel 200), the first pump 101 and the second pump 102 have difficulty suctioning the ink, making it difficult to fill the printing head 21 and the circulation liquid channel with the ink. In the present embodiment, the recovery unit 160 applies negative pressure to the circulation liquid channel through the printing head 21, making it possible to improve the ability to fill the printing head 21 and the circulation liquid channel with the ink.

In the next Step, S109, the circulation control unit 505 determines whether the weight detected by the weight sensor has decreased by more than a predetermined amount of decrease. The amount of decrease in weight detected by the weight sensor corresponds to the amount of decrease in weight of the ink stored in the buffer tank 108. The predetermined amount of decrease is set to an ink filling amount (weight) in the supply channel 200 such that the first pump 101 and the second pump 102 are filled with the ink but the choke valve 118 is not filled with the ink. If the weight detected by the weight sensor has not decreased by more than the predetermined amount of decrease, that is, if the determination result in Step S109 is NO, the processing of Step S109 is repeated. If the weight detected by the weight sensor has decreased by more than the predetermined amount of decrease, that is, if the determination result in Step S109 is YES, the processing proceeds to Step S110. If Step S109 is executed a predetermined number of times, or if the determination result is NO even after a predetermined time has elapsed since the start of Step S108, the CPU 511 executes processing to notify the user of an error due to a problem with the ink supply. For example, the CPU 511 displays the error on the operation panel.

In Step S110, the first pump 101 and the second pump 102 of the circulation unit 100 stop. In this event, the pressure inside the supply channel 200 is released to atmospheric pressure.

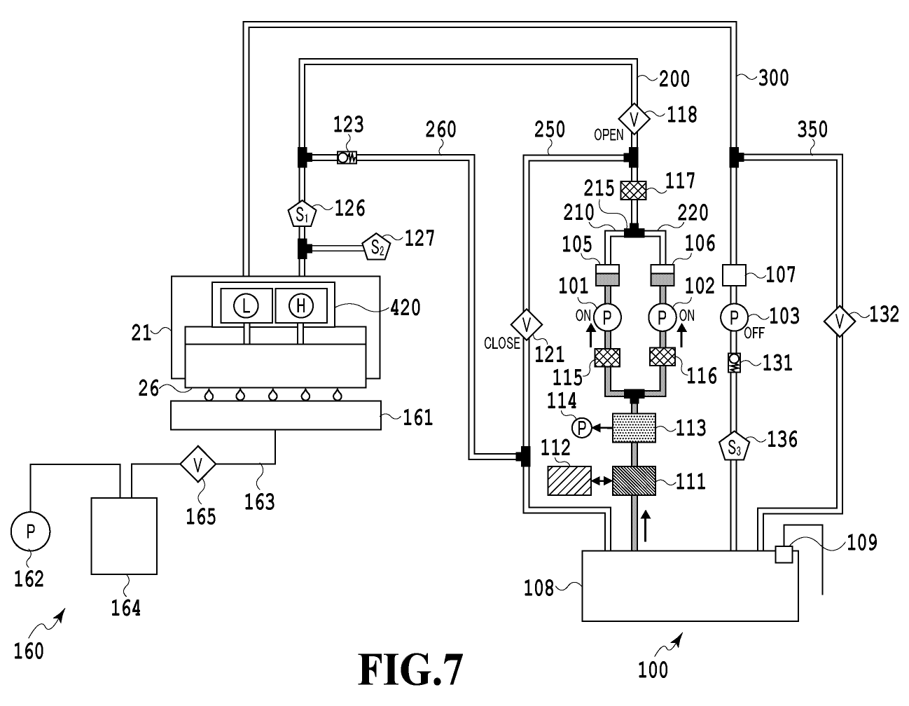

FIG. 7 is an explanatory diagram showing a state where the ink is filled up to the first pump 101 and the second pump 102. As shown in FIG. 7, the first choke suction fills the first pump 101 and the second pump 102 with the ink. If the first choke suction does not fill the first pump 101 and the second pump 102 with the ink, the first pump 101 and the second pump 102 will have difficulty suctioning the ink. This may cause the first pump 101 and the second pump 102 to take long to send the ink, or may cause the first pump 101 and the second pump 102 to be unable to send the ink.

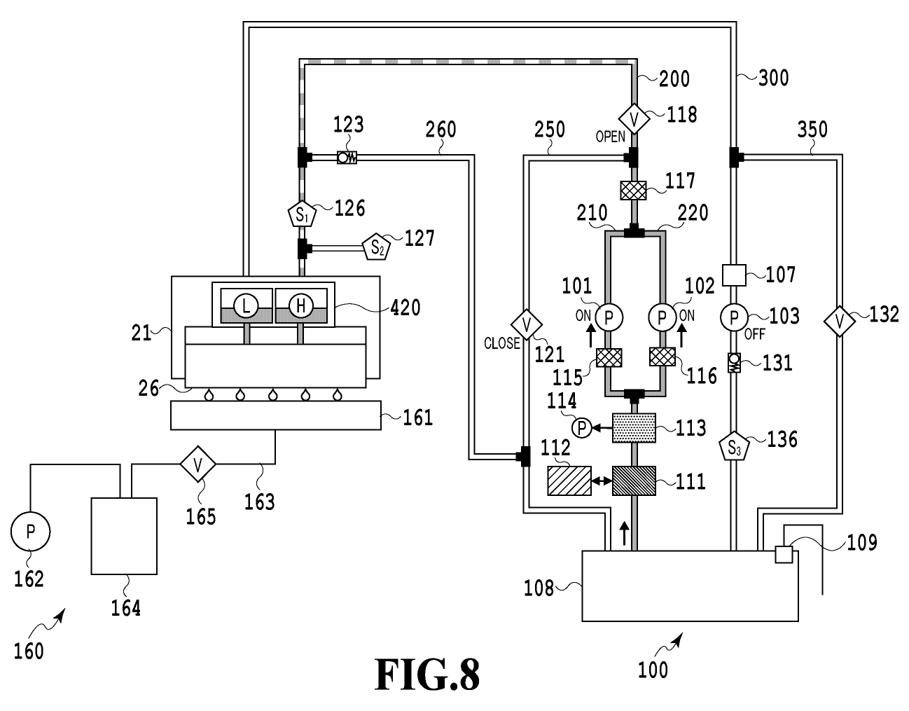

FIG. 8 is an explanatory diagram showing a state where the ink is filled up to a part of the supply channel 200 past the choke valve 118. It is preferable that the first choke suction fills the supply channel 200 with the ink up to just before the choke valve 118. As shown in FIG. 8, if the first conduit section 105 and the second conduit section 106 are not provided, the supply channel 200 is rapidly filled with the ink during the first choke suction, making it easier for the supply channel 200 to be filled with the ink up to the portion past the choke valve 118. As the ink is filled up to the portion of the supply channel 200 past the choke valve 118 by the first choke suction, the ink and gas are mixed in the portion of the supply channel 200 between the choke valve 118 and the printing head 21. If the ink filling operation is carried on with the ink and gas mixed in the supply channel 200, air bubbles may enter the negative pressure control unit 420 of the printing head 21. If air bubbles enter the negative pressure control unit 420, sticking matter is formed by the air bubbles entering the negative pressure control unit 420. The sticking matter formed in the negative pressure control unit 420 may affect image quality by entering the ejection ports (not shown) of the printing head 21. To avoid air bubbles from entering the negative pressure control unit 420, the ink filling amount in the first choke suction is set to a filling amount such that the first pump 101 and the second pump 102 are filled with the ink but the choke valve 118 is not filled with the ink.

In the first choke suction, the ink sent from the first pump 101 and the second pump 102 is filled in the internal spaces of the first conduit section 105 and the second conduit section 106, which are larger in cross-section area than the supply channel 200 (first branching flow passage 210 and second branching flow passage 220). This can suppress rapid ink filling in the supply channel 200, thus making it possible to avoid the supply channel 200 from being filled with the ink past the choke valve 118.

In the present embodiment, the ink filling amount in the first choke suction is managed based on, but not limited to, the amount of decrease in weight of the ink stored in the buffer tank 108. The ink filling amount in the first choke suction may also be managed based on the elapsed time since the start of the operation of the first pump 101 and the second pump 102.

Referring back to FIG. 6, in the next Step S111, the choke valve 118 of the circulation unit 100 closes the supply channel 200. As described above, it is preferable that the supply channel 200 be filled with the ink up to the portion just before the choke valve 118.

In the next Step S112, the first solenoid valve 121 of the circulation unit 100 opens the supply-side air communicating channel 250. This causes the downstream side of the first branching flow passage 210 and the second branching flow passage 220 to be communicated with the buffer tank 108 through the supply-side air communicating channel 250.

In the next Step S113, the first pump 101 of the circulation unit 100 starts its operation. In this case, with the choke valve 118 closed and the first solenoid valve 121 opened, the ink stored in the buffer tank 108 passes through the supply channel 200 (first branching flow passage 210) and the supply-side air communicating channel 250 before returning to the buffer tank 108. Therefore, the operation of the first pump 101 circulates the ink through the supply channel 200 (first branching flow passage 210), the supply-side air communicating channel 250, and the buffer tank 108.

In the next Step S114, the circulation control unit 505 determines whether the operating time of the first pump 101 is greater than or equal to a predetermined time. If the operating time of the first pump 101 is less than the predetermined time, that is, if the determination result in Step S114 is NO, the processing of Step S114 is repeated. If the operating time of the first pump 101 is greater than or equal to the predetermined time, that is, if the determination result in Step S114 is YES, the processing proceeds to Step S115.

In Step S115, the first pump 101 of the circulation unit 100 stops. This stops the ink circulation by the first pump 101.

In the next Step S116, the second pump 102 of the circulation unit 100 starts its operation. In this case, with the choke valve 118 closed and the first solenoid valve 121 opened, the ink stored in the buffer tank 108 passes through the supply channel 200 (second branching flow passage 220) and the supply-side air communicating channel 250 before returning to the buffer tank 108. Therefore, the operation of the second pump 102 circulates the ink through the supply channel 200 (second branching flow passage 220), the supply-side air communicating channel 250, and the buffer tank 108.

In the next Step S117, the circulation control unit 505 determines whether the operating time of the second pump 102 is greater than or equal to a predetermined time. If the operating time of the second pump 102 is less than the predetermined time, that is, if the determination result in Step S117 is NO, the processing of Step S117 is repeated. If the operating time of the second pump 102 is greater than or equal to the predetermined time, that is, if the determination result in Step S117 is YES, the processing proceeds to Step S118.

In Step S118, the second pump 102 of the circulation unit 100 stops. This stops the ink circulation by the second pump 102. Note that the first pump 101 of the circulation unit 100 is operated first in the present embodiment, but the second pump 102 may be operated first.

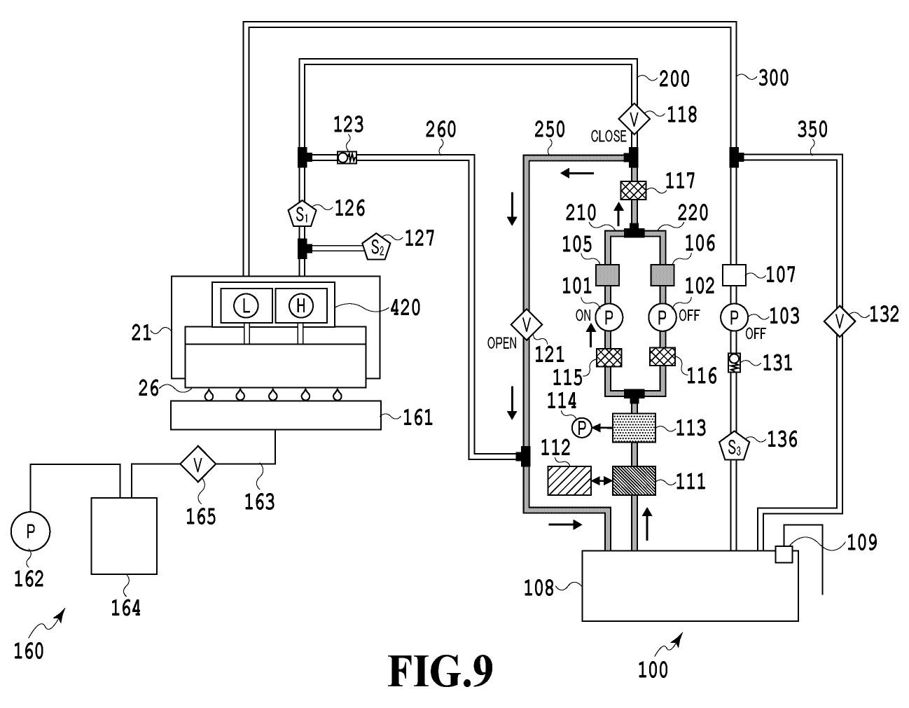

FIG. 9 is an explanatory diagram showing a state where ink is filled up to the supply-side air communicating channel 250 from the supply channel 200. As shown in FIG. 9, the operation of the first pump 101 or the second pump 102 circulates the ink through the supply channel 200, the supply-side air communicating channel 250, and the buffer tank 108, thereby filling the supply channel 200 with the ink up to the supply-side air communicating channel 250. Furthermore, by alternately operating the first pump 101 and the second pump 102 to circulate the ink, air bubbles present in the supply channel 200 up to the portion just before the choke valve 118 can be discharged to the buffer tank 108 through the supply-side air communicating channel 250.

Referring back to FIG. 6, in Step S119, the suction solenoid valve 165 of the recovery unit 160 opens the flow path in the suction pipe 163. With the cap 161 capping the ejection surface 26 of the printing head 21, the suction solenoid valve 165 opens the flow path in the suction pipe 163, allowing the recovery unit 160 to apply negative pressure to the circulation liquid channel through the printing head 21.

In Step S120, the choke valve 118 and the first solenoid valve 121 of the circulation unit 100 close a part of the circulation liquid channel. In this event, the choke valve 118 closes the supply channel 200 filled with ink up to just before the choke valve 118. The first solenoid valve 121 closes the supply-side air communicating channel 250 filled with ink. Note that the order of Steps S119 and S120 may be reversed. Steps S119 and S120 may be performed in parallel. Furthermore, the second solenoid valve 132 may close or open the collection-side air communicating channel 350.

In the next Step S121, the suction pump 162 of the recovery unit 160 starts its operation. With the flow path in the suction pipe 163 opened by the suction solenoid valve 165, the operation of the suction pump 162 causes negative pressure to act on the circulation liquid channel (supply channel 200) through the printing head 21. The magnitude of the negative pressure acting on the supply channel 200 is detected by the pressure sensor 127.

In the next Step S122, the circulation control unit 505 determines whether the magnitude (pressure value) of the negative pressure detected by the pressure sensor 127 is greater than or equal to a predetermined value. If the pressure value detected by the pressure sensor 127 is less than the predetermined value, that is, if the determination result in Step S122 is NO, the processing of Step S122 is repeated. If the pressure value detected by the pressure sensor 127 is greater than or equal to the predetermined value, that is, if the determination result in Step S122 is YES, the processing proceeds to Step S123. If Step S122 is executed a predetermined number of times, or if the determination result is NO even after a predetermined time has elapsed since the start of Step S121, the CPU 511 executes processing to notify the user of an error due to a problem with the ink supply. For example, the CPU 511 displays the error on the operation panel.

In Step S123, the suction pump 162 of the recovery unit 160 stops. In this event, with the supply channel 200 closed by the choke valve 118 of the circulation unit 100, negative pressure acts on the printing head 21 and the circulation liquid channel (supply channel 200).

In the next Step S124, the choke valve 118 opens the supply channel 200. This allows ink to flow into the portion of the supply channel 200 downstream of the choke valve 118 by using the negative pressure applied to the supply channel 200 through the printing head 21.

In the next Step S125, the first pump 101 and the second pump 102 of the circulation unit 100 start their operation. With the choke valve 118 opened and the first solenoid valve 121 closed, the operation of the first pump 101 and the second pump 102 fills the supply channel 200 and the printing head 21 with the ink stored in the buffer tank 108.

In the next Step S126, the first pump 101 and the second pump 102 of the circulation unit 100 stop. The operations of Steps S119 to S126 are also referred to as second choke suction. The ink filling amount in the second choke suction may be managed based on the amount of decrease in weight of the ink stored in the buffer tank 108. The ink filling amount in the second choke suction may also be managed based on the elapsed time since the start of the operation of the first pump 101 and the second pump 102.

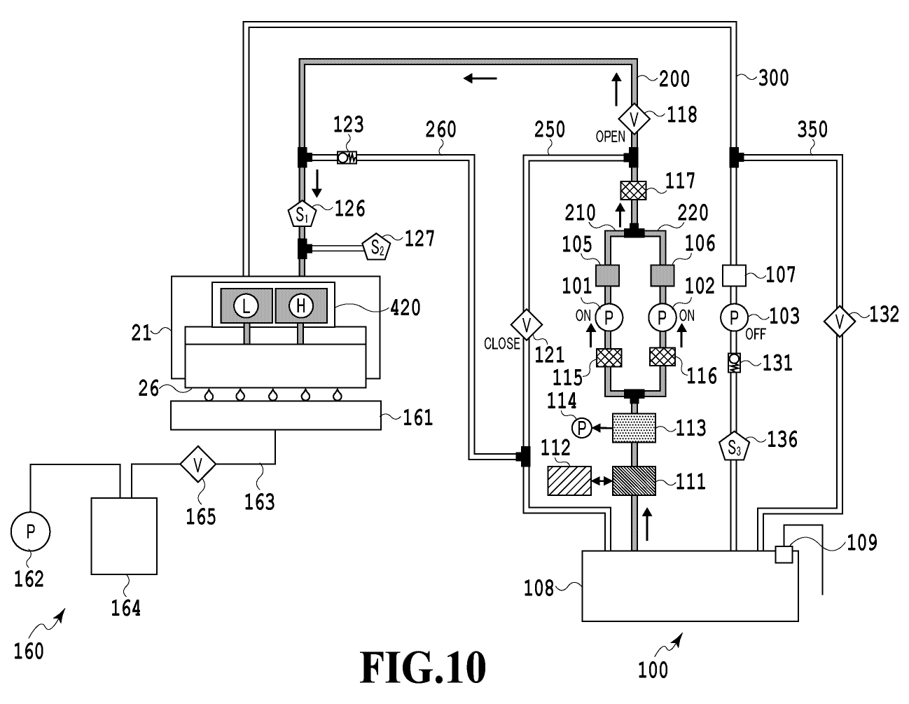

FIG. 10 is an explanatory diagram showing a state where the supply channel 200 and the printing head 21 are filled with ink. As the second choke suction is performed with the supply channel 200 filled with ink up to just before the choke valve 118, gas (air) remaining in the supply channel 200 is first discharged. Next, as shown in FIG. 10, the ink in the supply channel 200 is discharged from the choke valve 118 to the cap 161 of the recovery unit 160 through the downstream side of the supply channel 200 and the inside of the printing head 21. This makes it possible to suppress air bubbles from entering the negative pressure control unit 420 of the printing head 21 during the ink filling operation.

Then, in Step S127, the first pump 101, the second pump 102, and the third pump 103 of the circulation unit 100 start their operation. In this event, the choke valve 118 opens the supply channel 200. The first solenoid valve 121 closes the supply-side air communicating channel 250. The second solenoid valve 132 closes the collection-side air communicating channel 350. Through the operation of the first pump 101, the second pump 102, and the third pump 103, the ink is also filled in the collecting channel 300 through the supply channel 200 and the printing head 21. The ink filling operation is thus completed, and ink circulation starts in the circulation liquid channel.

In the present embodiment, the first conduit section 105, the conduit section 106, and the third conduit section 107 are arranged along a direction in which the ink flows from the lower side to the upper side in the vertical direction. This suppresses generation of relatively large air bubbles inside the first conduit section 105, the conduit section 106, and the third conduit section 107, thus making it possible to suppress air bubbles from entering the inside (negative pressure control unit 420) of the printing head 21. The first conduit section 105, the conduit section 106, and the third conduit section 107 are also larger in cross-section area than the supply channel 200 and the collecting channel 300. This can reduce pulsation generated as the first pump 101 and the second pump 102 send the ink, as well as pulsation of ink discharged from the printing head 21. Furthermore, even if the ink and the gas mix in the supply channel 200 during the ink filling operation, air bubbles can be contained inside the first conduit section 105 and the second conduit section 106, thus suppressing the air bubbles from entering the inside of the printing head 21.

### Configuration of Pump

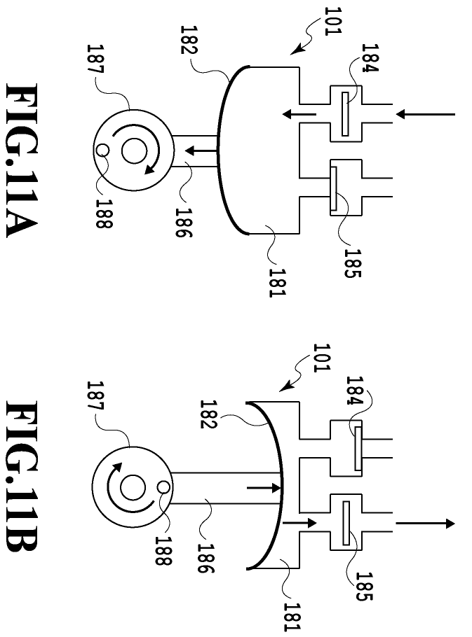

Next, the first to third pumps 101 to 103 will be described. FIGS. 11A and 11B are schematic diagrams showing an example of the first pump 101. FIG. 11A is a schematic diagram showing the first pump 101 having its inner volume expanded. FIG. 11B is a schematic diagram showing the first pump 101 having its inner volume reduced. The second pump 102 and the third pump 103 have the same configuration as that of the first pump 101. Therefore, detailed description of the second pump 102 and the third pump 103 will be omitted.

As previously mentioned, the first pump 101, the second pump 102, and the third pump 103 are each configured using a diaphragm pump, which is a type of positive-displacement pump. As shown in FIGS. 11A and 11B, the first pump 101 includes a pump body 181 having a diaphragm rubber 182, an inlet valve 184, an outlet valve 185, an arm 186, and a turning body 187. The diaphragm rubber 182 is made of an elastically deformable rubber material. The inner volume of the pump body 181 changes as the diaphragm rubber 182 elastically deforms. The arm 186 has one end portion connected to the diaphragm rubber 182.

The inlet valve 184 is configured using a check valve. The inlet valve 184 is attached to an inlet portion of the pump body 181 facing the diaphragm rubber 182. The inlet valve 184 communicates with the inside of the pump body 181 and the upstream side of the first branching flow passage 210. The inlet valve 184 regulates the flow of ink from inside the pump body 181 toward the upstream side of the first branching flow passage 210, while allowing ink to flow from the upstream side of the first branching flow passage 210 toward the inside of the pump body 181. In this way, the inlet valve 184 suppresses backflow of ink at the inlet portion of the pump body 181.

The outlet valve 185 is configured using a check valve. The outlet valve 185 is attached to an outlet portion of the pump body 181 facing the diaphragm rubber 182. The outlet valve 185 communicates with the inside of the pump body 181 and the downstream side of the first branching flow passage 210. The outlet valve 185 regulates the flow of ink from the downstream side of the first branching flow passage 210 toward the inside of the pump body 181, while allowing ink to flow from the inside of the pump body 181 toward the downstream side of the first branching flow passage 210. In this way, the outlet valve 185 suppresses backflow of ink at the outlet portion of the pump body 181.

The arm 186 is disposed between the diaphragm rubber 182 and the turning body 187. The arm 186 has one end portion connected to the diaphragm rubber 182. The other end portion of the arm 186 is connected to the turning body 187 using a connecting pin 188. The connecting pin 188 is provided at an eccentric position on the turning body 187. As the turning body 187 turns, the arm 186 can reciprocally move between an expanded position (see FIG. 11A) where the inner volume of the pump body 181 is expanded and a contracted position (see FIG. 11B) where the inner volume of the pump body 181 is contracted.

As shown in FIG. 11A, as the arm 186 moves to the expanded position, the diaphragm rubber 182 elastically deforms so as to move away from the inlet valve 184 and the outlet valve 185. This increases the inner volume of the pump body 181 and reduces the pressure inside the pump body 181. The outlet valve 185 closes and the inlet valve 184 opens as the pressure inside the pump body 181 is reduced, causing ink on the upstream side of the first branching flow passage 210 to flow into the pump body 181 through the inlet valve 184.

As shown in FIG. 11B, as the arm 186 moves to the contracted position, the diaphragm rubber 182 elastically deforms so as to move closer to the inlet valve 184 and the outlet valve 185. This reduces the inner volume of the pump body 181 and increases the pressure inside the pump body 181. The inlet valve 184 closes and the outlet valve 185 opens as the pressure inside the pump body 181 is increased, causing the ink inside the pump body 181 to flow out to the downstream side of the first branching flow passage 210 through the outlet valve 185.

As the arm 186 keeps moving reciprocally between the expanded position and the contracted position, an ink flow is generated inside the pump body 181, from the upstream side to the downstream side of the first branching flow passage 210. The continuous inflow and outflow of ink causes pressure fluctuations inside the pump body 181. Based on the pressure fluctuations caused inside the pump body 181, the ink moves in a pulse-like manner, that is, pulsation occurs. Stable ink ejection from the printing head 21 requires maintaining the pressure inside the channel near the printing head 21 within a certain range. Therefore, the pulsation needs to be suppressed within a predetermined range. Instead of the diaphragm pumps, tube pumps or the like can be used for the first pump 101, the second pump 102, and the third pump 103. As in the case of the diaphragm pump, pulsation may also be caused in the tube pump or the like by alternating suction and ejection of ink.

### Configuration of Conduit Section

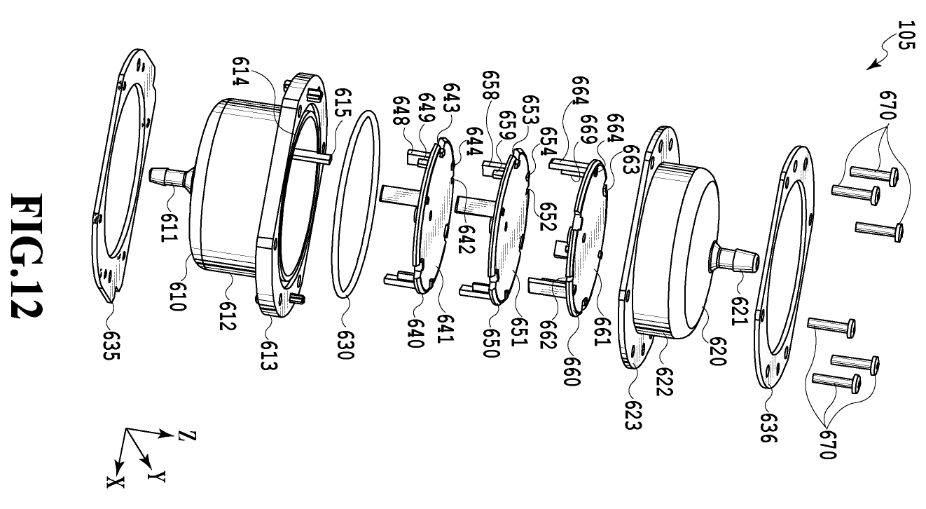

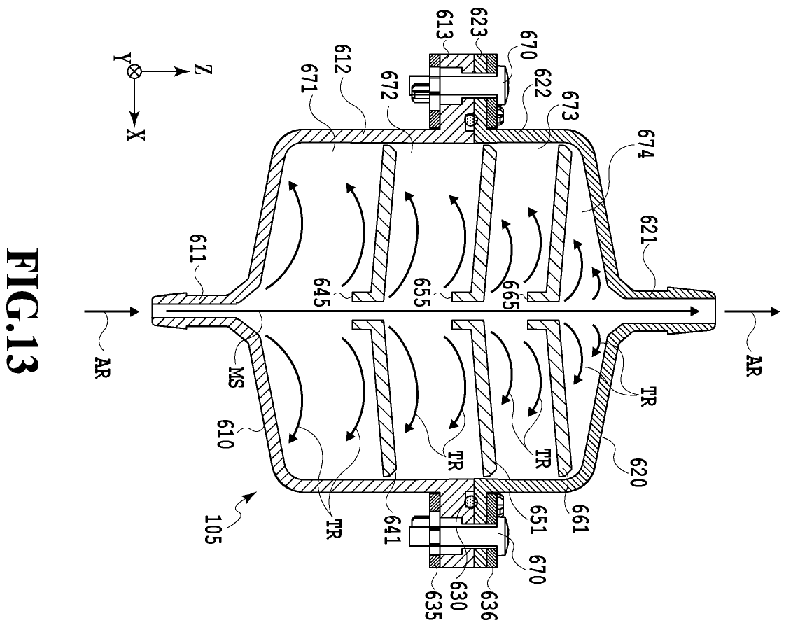

Next, the first to third conduit sections 105 to 107 will be described. In the present embodiment, description will be given of a configuration capable of suppressing the pulsation of ink (liquid) supplied to the printing head 21. FIG. 12 is an exploded view of the first conduit section 105. FIG. 13 is a sectional side view of the first conduit section 105. Note that the second conduit section 106 and the third conduit section 107 have the same configuration as that of the first conduit section 105. Therefore, detailed description of the second conduit section 106 and the third conduit section 107 will be omitted.

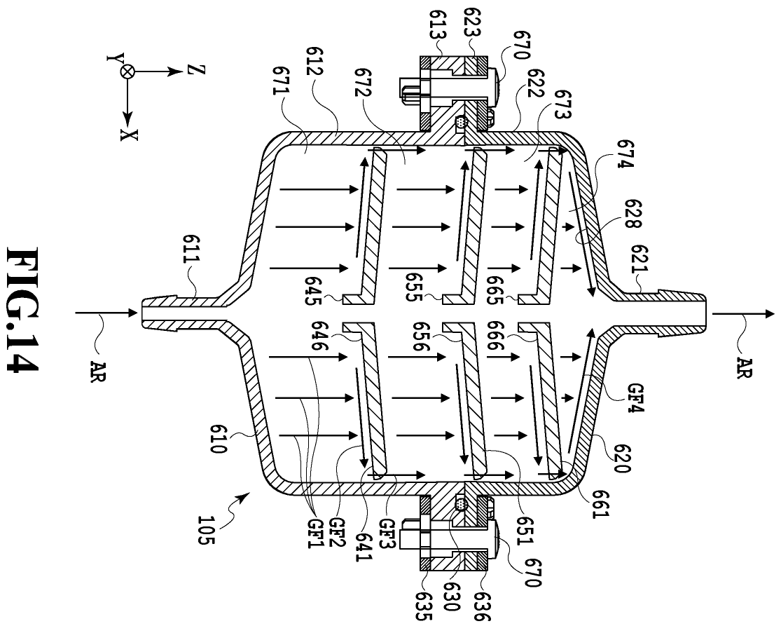

As shown in FIGS. 12 and 13, the first conduit section 105 has a lower cylinder 610, an upper cylinder 620, a sealing member 630, a lower holding plate 635, an upper holding plate 636, a lower inner plate 640, an intermediate inner plate 650, and an upper inner plate 660. The arrows AR in FIG. 13 indicate the ink flow direction. The ink flow direction is a vertically upward direction (+Z direction). The first conduit section 105 is disposed along the direction in which ink flows from the lower side to the upper side in the vertical direction. Note that the arrows AR also indicate the ink flow direction in FIGS. 14 to 20, 25, 28, 31, and 32 to be described later.

The lower cylinder 610 is formed in a cylindrical shape extending in the ink flow direction (Z direction). The lower cylinder 610 has an inlet pipe 611, a lower expanded pipe 612, and a lower flange portion 613. The inlet pipe 611 is formed in a tubular shape that protrudes vertically downward (-Z direction) in the central portion of the lower base of the lower expanded pipe 612. The inlet pipe 611 is connected to the upstream side of the first branching flow passage 210. The inlet pipe 611 communicates with the inside of the first conduit section 105 (the lower expanded pipe 612 and an upper expanded pipe 622) and the upstream side of the first branching flow passage 210. This allows the ink flowing through the first branching flow passage 210 to flow vertically upward through the inlet pipe 611. The lower expanded pipe 612 is formed on the downstream side of (above) the inlet pipe 611 in the lower cylinder 610. The cross-section area of the internal space of the lower expanded pipe 612 is larger than the cross-section area of the internal space of the inlet pipe 611. The lower flange portion 613 is formed in the upper edge of the side portion of the lower expanded pipe 612. A seal groove portion 614 is formed on the upper surface of the lower flange portion 613 so as to extend in an annular shape. A sealing member 630 is fitted into the seal groove portion 614. The lower surface side of the lower flange portion 613 is held by the lower holding plate 635. In addition, a rib 615 extending in the vertical direction is formed on the inner periphery of the lower expanded pipe 612.

The upper cylinder 620 is formed in a cylindrical shape extending in the ink flow direction (Z direction). The upper cylinder 620 has an outlet pipe 621, the upper expanded pipe 622, and an upper flange portion 623. The outlet pipe 621 is formed in a tubular shape that protrudes vertically upward (+Z direction) in the central portion of the upper base of the upper expanded pipe 622. The outlet pipe 621 is connected to the downstream side of the first branching flow passage 210. The outlet pipe 621 communicates with the inside of the first conduit section 105 (the lower expanded pipe 612 and the upper expanded pipe 622) and the downstream side of the first branching flow passage 210. This allows the ink flowing through the lower expanded pipe 612 and the upper expanded pipe 622 to flow out vertically upward into the first branching flow passage 210 through the outlet pipe 621. The upper expanded pipe 622 is formed on the upstream side of (below) the outlet pipe 621 in the upper cylinder 620. The cross-section area of the internal space of the upper expanded pipe 622 is the same as that of the lower expanded pipe 612. The cross-section area of the internal space of the upper expanded pipe 622 (and the lower expanded pipe 612) is larger than that of the inlet pipe 611 and that of the outlet pipe 621. The cross-section area of the internal space of the outlet pipe 621 is also slightly larger than that of the inlet pipe 611. The upper flange portion 623 is formed on the lower edge of the side portion of the upper expanded pipe 622. The lower surface of the upper flange portion 623 abuts against the upper surface of the lower flange portion 613 of the lower cylinder 610, which has the sealing member 630 fitted in the seal groove portion 614. The upper surface side of the upper flange portion 623 is held by the upper holding plate 636.

The sealing member 630 is formed in a ring shape using an O-ring, for example. The O-ring material used for the sealing member 630 is, for example, ethylene propylene diene rubber (EPDM), fluoro-rubber or the like. The sealing member 630 comes into contact with the lower flange portion 613 of the lower cylinder 610 and the upper flange portion 623 of the upper cylinder 620 and is crushed while being fitted into the seal groove portion 614 of the lower cylinder 610. This allows the sealing member 630 to seal the inside of the first conduit section 105 formed by joining the upper cylinder 620 and the lower cylinder 610, thereby suppressing the ink and the like from leaking out of the first conduit section 105.

The lower holding plate 635 and the upper holding plate 636 are formed into a doughnut-shaped plate using a metal plate material. The lower holding plate 635 and the upper holding plate 636 are fastened together using screws 670 while sandwiching the lower flange portion 613 of the lower cylinder 610 and the upper flange portion 623 of the upper cylinder 620. The lower cylinder 610 and the upper cylinder 620 are thus joined to form the first conduit section 105, allowing the lower holding plate 635 and the upper holding plate 636 to receive the pressure inside the first conduit section 105. Therefore, even if the pressure inside the first conduit section 105 increases, deformation of the sealing member 630 is suppressed, thereby suppressing the ink and the like from leaking out of the first conduit section 105 due to deformation of the sealing member 630.

The lower inner plate 640 is provided on the lower side inside the first conduit section 105. The lower inner plate 640 is formed in a disk shape that matches the inner circumferential shape of the first conduit section 105. The lower inner plate 640 has a lower partition 641 and three lower leg portions 648. The lower partition 641 divides the internal space of the first conduit section 105 (the lower expanded pipe 612 and the upper expanded pipe 622) along the extending direction of the lower expanded pipe 612 and the upper expanded pipe 622. In the lower partition 641, one lower engagement groove 642, three lower notch portions 643, and three lower pedestals 644 are formed. The lower engagement groove 642 is formed on the outer periphery of the lower partition 641 and engages with the rib 615 of the lower cylinder 610. The position of the lower inner plate 640 relative to the lower cylinder 610 in the outer peripheral direction is thus determined. The lower notch portions 643 are formed in positions different from that of the lower engagement groove 642 on the outer periphery of the lower partition 641. The lower pedestals 644 are formed in positions overlapping with the lower leg portions 648 on the upper surface of the lower partition 641. The lower leg portions 648 are formed so as to protrude downward on the lower surface side of the outer periphery of the lower partition 641. A convex portion 649 is formed on the inner surface of the lower leg portion 648.

The lower leg portions 648 are placed on protrusions (not shown) formed on the lower base of the lower expanded pipe 612. Accordingly, a first extended space 671 (see FIG. 13) is formed between the lower partition 641 and the lower base of the lower expanded pipe 612, determining the length of the first extended space 671 in the extending direction (Z direction) of the lower expanded pipe 612 and the upper expanded pipe 622.

The intermediate inner plate 650 is provided in the middle inside the first conduit section 105. The intermediate inner plate 650 is formed to have the same shape in design as the lower inner plate 640. The intermediate inner plate 650 has an intermediate partition 651 and three intermediate leg portions 658. The intermediate partition 651 divides the internal space of the first conduit section 105 (the lower expanded pipe 612 and the upper expanded pipe 622) along the extending direction of the lower expanded pipe 612 and the upper expanded pipe 622. In the intermediate partition 651, one intermediate engagement groove 652, three intermediate notch portions 653, and three intermediate pedestals 654 are formed. The intermediate engagement groove 652 is formed on the outer periphery of the intermediate partition 651 and engages with the rib 615 of the lower cylinder 610. The position of the intermediate inner plate 650 relative to the lower cylinder 610 in the outer peripheral direction is thus determined. The intermediate notch portions 653 are formed in positions different from that of the intermediate engagement groove 652 on the outer periphery of the intermediate partition 651. The intermediate pedestals 654 are formed in positions overlapping with the lower leg portions 648 on the upper surface of the intermediate partition 651. The intermediate leg portions 658 are formed so as to protrude downward on the lower surface side of the outer periphery of the intermediate partition 651. An intermediate convex portion 659 is formed on the inner surface of the intermediate leg portion 658.

The intermediate leg portions 658 are placed on the lower pedestals 644 of the lower inner plate 640. Accordingly, a second extended space 672 (see FIG. 13) is formed between the intermediate partition 651 and the lower partition 641. The length of the second extended space 672 in the extending direction (Z direction) of the lower expanded pipe 612 and the upper expanded pipe 622 is shorter than the length of the first extended space 671.

The upper inner plate 660 is provided on the upper side inside the first conduit section 105. The upper inner plate 660 is formed to have the same shape in design as the lower inner plate 640 and the intermediate inner plate 650. The upper inner plate 660 has an upper partition 661 and three upper leg portions 668. The upper partition 661 divides the internal space of the first conduit section 105 (the lower expanded pipe 612 and the upper expanded pipe 622) along the extending direction of the lower expanded pipe 612 and the upper expanded pipe 622. In the upper partition 661, one upper engagement groove 662, three upper notch portions 663, and three upper pedestals 664 are formed. The upper engagement groove 662 is formed on the outer periphery of the upper partition 661. The upper notch portions 663 are formed in positions different from that of the upper engagement groove 662 on the outer periphery of the upper partition 661. The upper pedestals 664 are formed in positions overlapping with the upper leg portions 668 on the upper surface of the upper partition 661. The upper leg portions 668 are formed so as to protrude downward on the lower surface side of the outer periphery of the upper partition 661. An upper convex portion 669 is formed on the inner surface of the upper leg portion 668. The upper leg portion 668 is inserted into the intermediate engagement groove 652 of the intermediate inner plate 650, and the upper convex portion 669 is placed on a portion of the intermediate partition 651 adjacent to the intermediate engagement groove 652.

Accordingly, a third extended space 673 (see FIG. 13) is formed between the upper partition 661 and the intermediate partition 651, and a fourth extended space 674 (see FIG. 13) is formed between the upper partition 661 and the upper base of the upper expanded pipe 622. The upper cylinder 620 (upper expanded pipe 622) regulates the movement of the upper inner plate 660 to the downstream side (upward) of the upper expanded pipe 622. The length of the third extended space 673 in the extending direction (Z direction) of the lower expanded pipe 612 and the upper expanded pipe 622 is shorter than the length of the second extended space 672. Similarly, the length of the fourth extended space 674 in the extending direction of the lower expanded pipe 612 and the upper expanded pipe 622 is shorter than the length of the third extended space 673. Although the lower inner plate 640, the intermediate inner plate 650, and the upper inner plate 660 have the same shape in design, the length of each extended space in the extending direction of the lower expanded pipe 612 and the upper expanded pipe 622 becomes shorter toward the downstream side.

As shown in FIG. 13, the lower partition 641, the intermediate partition 651, and the upper partition 661 are disposed in this order from the upstream side in the first conduit section 105. The lower partition 641, the intermediate partition 651, and the upper partition 661 divide the internal space of the first conduit section 105 (the lower expanded pipe 612 and the upper expanded pipe 622), forming a plurality of extended spaces aligned in the extending direction of the lower expanded pipe 612 and the upper expanded pipe 622. Specifically, the first extended space 671, the second extended space 672, the third extended space 673, and the fourth extended space 674 are formed in this order from the upstream side.

As shown in FIG. 13, a lower through-hole portion 645 is formed in the central portion of the disk-shaped lower partition 641 so as to penetrate the lower partition 641. The lower through-hole portion 645 is formed in a cylindrical shape that protrudes from the lower partition 641 toward the upstream side of the lower expanded pipe 612 and the upper expanded pipe 622. An intermediate through-hole portion 655 is formed in the central portion of the disk-shaped intermediate partition 651 so as to penetrate the intermediate partition 651. The intermediate through-hole portion 655 is formed in a cylindrical shape that protrudes from the intermediate partition 651 toward the upstream side of the lower expanded pipe 612 and the upper expanded pipe 622. An upper through-hole portion 665 is formed in the central portion of the disk-shaped upper partition 661 so as to penetrate the upper partition 661. The upper through-hole portion 665 is formed in a cylindrical shape that protrudes from the upper partition 661 toward the upstream side of the lower expanded pipe 612 and the upper expanded pipe 622.

In the present embodiment, the inlet pipe 611 has an inner diameter of, for example, 2.6 mm. The outlet pipe 621 has an inner diameter of, for example, 4 mm. The lower through-hole portion 645, the intermediate through-hole portion 655, and the upper through-hole portion 665 have an inner diameter of, for example, 3 mm. The internal spaces of the lower through-hole portion 645, the intermediate through-hole portion 655, and the upper through-hole portion 665 are designed to have the same (substantially the same) cross-section area. In other words, the cross-section areas are the same if there are no design tolerances, but may vary. The cross-section areas of the internal spaces of the lower through-hole portion 645, the intermediate through-hole portion 655, and the upper through-hole portion 665 are larger than the cross-section area of the internal space of the inlet pipe 611 and smaller than the cross-section area of the internal space of the outlet pipe 621. Furthermore, the inlet pipe 611, the through-hole portions formed in the plurality of partitions (the lower through-hole portion 645, the intermediate through-hole portion 655, and the upper through-hole portion 665), and the outlet pipe 621 are designed to be coaxially disposed. As a result, the cross section of the internal space of the inlet pipe 611 as seen from the upstream side of the first conduit section 105 overlaps with the cross sections of the internal spaces of the lower through-hole portion 645, the intermediate through-hole portion 655, and the upper through-hole portion 665. The cross sections of the internal spaces of the lower through-hole portion 645, the intermediate through-hole portion 655, and the upper through-hole portion 665 as seen from the upstream side of the first conduit section 105 overlap with the cross section of the internal space of the outlet pipe 621.

The ink sent by the first pump 101 through the first branching flow passage 210 flows from the inlet pipe 611 into the first conduit section 105. Inside the first conduit section 105, the ink flows into the first extended space 671 through the inlet pipe 611. The ink flowing into the first extended space 671 flows into the second extended space 672 through the first extended space 671 and the lower through-hole portion 645. The ink flowing into the second extended space 672 flows into the third extended space 673 through the second extended space 672 and the intermediate through-hole portion 655. The ink flowing into the third extended space 673 flows into the fourth extended space 674 through the third extended space 673 and the upper through-hole portion 665. The ink flowing into the fourth extended space 674 flows out to the downstream side of the first branching flow passage 210 through the fourth extended space 674 and the outlet pipe 621.

The main flow of ink (main stream MS) inside the first conduit section 105 flows along the central axes of the inlet pipe 611, the through-hole portions (lower through-hole portion 645, intermediate through-hole portion 655, and upper through-hole portion 665), and the outlet pipe 621. At locations where the cross-section area of the internal space of the first conduit section 105 suddenly expands, such as the upstream end of each of the extended spaces 671 to 674, the flow of ink separated from the main stream MS becomes a turbulent vortex, causing pressure loss. Similarly, at locations where the cross-section area of the internal space of the first conduit section 105 suddenly contracts, such as the downstream end of each of the extended spaces 671 to 674, the flow of ink separated from the main stream MS becomes a turbulent vortex, causing pressure loss. Such pressure loss caused in the internal space of the first conduit section 105 reduces ink pulsation.

Since turbulence can cause pulsation, the ink main stream MS is preferably a laminar flow. It is also preferable that the central axes of the inlet pipe 611, the through-hole portions (lower through-hole portion 645, intermediate through-hole portion 655, and upper through-hole portion 665), and the outlet pipe 621 are substantially aligned with each other. This reduces the possibility of the ink main stream MS colliding with the partitions (lower partition 641, intermediate partition 651, and upper partition 661), making it possible to avoid the main stream MS from becoming turbulent. In the present embodiment, the cross section of the internal space of the inlet pipe 611 as seen from the upstream side of the first conduit section 105 overlaps with the cross sections of the internal spaces of the lower through-hole portion 645, the intermediate through-hole portion 655, and the upper through-hole portion 665. The cross sections of the internal spaces of the lower through-hole portion 645, the intermediate through-hole portion 655, and the upper through-hole portion 665 as seen from the upstream side of the first conduit section 105 overlap with the cross section of the internal space of the outlet pipe 621. This allows the central axes of the inlet pipe 611, the through-hole portions, and the outlet pipe 621 to be substantially aligned with each other, thus reducing the possibility of the ink main stream MS colliding with the partitions. This makes it possible to avoid the ink main stream MS from becoming turbulent, and to reduce the ink pulsation.

Most of the channels such as the supply channel 200 and the collecting channel 300 are formed using tubes. Reducing the inner diameter of the tube through which the ink flows increases pressure loss commensurately. Stable ink ejection from the printing head 21 requires maintaining the pressure inside the channel near the printing head 21 within a certain range. Therefore, it is necessary to minimize the pressure loss in the channel, excluding the conduit section for reducing the pulsation. In the present embodiment, the ink pulsation is reduced each time the ink passes through each of the extended spaces 671 to 674 and each of the through-hole portions (lower through-hole portion 645, intermediate through-hole portion 655, and upper through-hole portion 665). Therefore, the cross-section areas of the internal spaces of the lower through-hole portion 645, the intermediate through-hole portion 655, and the upper through-hole portion 665 may be larger than the cross-section area of the internal space of the inlet pipe 611. Similarly, the cross-section area of the internal space of the outlet pipe 621 may be larger than the cross-section areas of the internal spaces of the lower through-hole portion 645, the intermediate through-hole portion 655, and the upper through-hole portion 665. This can increase the inner diameter of the tube (first branching flow passage 210) connected to the outlet pipe 621. This eliminates the need to change the inner diameter of the tube on the downstream side of the first conduit section 105 (and the second conduit section 106). Thus, the pressure loss in the supply channel 200 near the printing head 21 can be reduced with a simple configuration.

Upon flowing into each through-hole portion, the ink main stream MS may entrain a flow of ink (hereinafter referred to as a tributary TR) stagnating near the partition, potentially causing turbulence in the ink main stream MS. In the present embodiment, the lower through-hole portion 645, the intermediate through-hole portion 655, and the upper through-hole portion 665 protrude toward the upstream side of the lower expanded pipe 612 and the upper expanded pipe 622. The protruding portions of the lower through-hole portion 645, intermediate through-hole portion 655, and upper through-hole portion 665 can avoid the ink main stream MS from entraining the tributary TR of ink stagnating near the partition. This reduces the generation of turbulence in the ink main stream MS, thus making it possible to reduce the ink pulsation.

Each partition may be provided with a plurality of through-hole portions protruding toward the upstream side of the lower expanded pipe 612 and the upper expanded pipe 622. In such a case, the protruding portion of each through-hole portion can avoid the ink main stream from entraining the tributary of ink stagnating near the partition. This makes it possible to reduce the ink pulsation.

In the present embodiment, the flow rate of ink flowing through the supply channel 200 is set to about 450 ml/min. In this case, the range over which the tributary TR of ink stagnating near the partition spreads radially in the width direction of the lower expanded pipe 612 and the upper expanded pipe 622 is about five times the inner diameter of each through-hole portion (lower through-hole portion 645, intermediate through-hole portion 655, and upper through-hole portion 665). If the inner diameters of the lower expanded pipe 612 and the upper expanded pipe 622 are smaller than the range over which the tributary TR of ink stagnating near the partition spreads, the generation of the tributary TR of ink is hindered. To enhance the effect of reducing the pulsation, the inner diameter of the lower expanded pipe 612 and the upper expanded pipe 622 is preferably larger than the range over which the tributary TR of ink stagnating near the partition spreads. Therefore, it is preferable that the inner diameter of the lower expanded pipe 612 and the upper expanded pipe 622 is more than or equal to five times the inner diameters of the lower through-hole portion 645, the intermediate through-hole portion 655, and the upper through-hole portion 665. The inner diameter of the lower expanded pipe 612 and the upper expanded pipe 622 is, for example, 54 mm. It is also preferable that the inner diameter of the lower expanded pipe 612 and the upper expanded pipe 622 is less than or equal to 25 times the inner diameters of the lower through-hole portion 645, the intermediate through-hole portion 655, and the upper through-hole portion 665. This makes it possible to suppress the lower expanded pipe 612 and the upper expanded pipe 622 from becoming larger, and thus to reduce the installation space for the conduit section. Based on the size relationship between the inner diameters described above, the cross-section areas of the internal spaces of the lower expanded pipe 612 and the upper expanded pipe 622 are preferably 25 to 625 times the cross-section areas of the internal spaces of the lower through-hole portion 645, the intermediate through-hole portion 655, and the upper through-hole portion 665.

### Air Flow Inside Conduit Section

Next, the flow of air (gas) inside the first conduit section 105 will be described. FIG. 14 is an explanatory diagram for explaining the flow of air inside the first conduit section 105. As shown in FIG. 14, a lower inclined surface 646 is formed on the lower surface side of the lower partition 641 so as to be inclined upward from the lower through-hole portion 645 of the lower partition 641 toward the outer periphery of the lower partition 641. This allows air contained in the ink in the first extended space 671 to move toward the outer periphery of the lower partition 641 along the lower inclined surface 646 of the lower partition 641. A gap communicating with the first extended space 671 and the second extended space 672 is formed between the outer periphery of the lower partition 641 and the side portion of the lower expanded pipe 612. This allows air that reaches the vicinity of the outer periphery of the lower partition 641 in the first extended space 671 to move to the second extended space 672 through the gap between the lower partition 641 and the lower expanded pipe 612. The width of the gap between the lower partition 641 and the lower expanded pipe 612 is smaller than or equal to the inner width of the lower through-hole portion 645. This makes it possible to suppress a decrease in the effect of reducing the pulsation.

A lower inclined surface 656 is formed on the lower surface side of the intermediate partition 651 so as to be inclined upward from the intermediate through-hole portion 655 of the intermediate partition 651 toward the outer periphery of the intermediate partition 651. This allows air contained in the ink in the second extended space 672 to move toward the outer periphery of the intermediate partition 651 along the lower inclined surface 656 of the intermediate partition 651. A gap communicating with the second extended space 672 and the third extended space 673 is formed between the outer periphery of the intermediate partition 651 and the side portion of the upper expanded pipe 622. This allows air that reaches the vicinity of the outer periphery of the intermediate partition 651 in the second extended space 672 to move to the third extended space 673 through the gap between the intermediate partition 651 and the upper expanded pipe 622. The width of the gap between the intermediate partition 651 and the upper expanded pipe 622 is smaller than or equal to the inner width of the intermediate through-hole portion 655. This makes it possible to suppress a decrease in the effect of reducing the pulsation.

A lower inclined surface 666 is formed on the lower surface side of the upper partition 661 so as to be inclined upward from the upper through-hole portion 665 of the upper partition 661 toward the outer periphery of the upper partition 661. This allows air contained in the ink in the third extended space 673 to move toward the outer periphery of the upper partition 661 along the lower inclined surface 666 of the upper partition 661. A gap communicating with the third extended space 673 and the fourth extended space 674 is formed between the outer periphery of the upper partition 661 and the side portion of the upper expanded pipe 622. This allows air that reaches the vicinity of the outer periphery of the upper partition 661 in the third extended space 673 to move into the fourth extended space 674 through the gap between the upper partition 661 and the upper expanded pipe 622. The width of the gap between the upper partition 661 and the upper expanded pipe 622 is smaller than or equal to the inner width of the upper through-hole portion 665. This makes it possible to suppress a decrease in the effect of reducing the pulsation.

Furthermore, an upper base inclined surface 628 is formed on the lower surface side of the upper base of the upper expanded pipe 622, which connects to the outlet pipe 621, so as to be inclined upward from the side portion of the upper expanded pipe 622 toward the outlet pipe 621. This allows air contained in the ink in the fourth extended space 674 to move toward the outlet pipe 621 along the upper base inclined surface 628 of the upper expanded pipe 622.

The air (gas) contained in the ink in the first to third extended spaces 671 to 673 moves toward the lower inclined surfaces 646, 656, and 666 of the respective partitions (lower partition 641, intermediate partition 651, and upper partition 661) along a first air flow GF1 directed vertically upward. The lower inclined surfaces 646, 656, 666 of the respective partitions are each inclined upward from the through-hole portion of each partition toward the outer periphery of each partition. Therefore, air that reaches the lower inclined surfaces 646, 656, 666 of the respective partitions moves toward the outer periphery of each partition along a second air flow GF2 directed obliquely upward. The air that reaches the vicinity of the outer periphery of each partition in the first to third extended spaces 671 to 673 moves to the downstream (upper) extended space along a third air flow GF3 directed vertically upward. The upper base inclined surface 628 of the upper expanded pipe 622 is inclined upward from the side portion of the upper expanded pipe 622 toward the outlet pipe 621. Therefore, air contained in the ink in the fourth extended space 674 moves toward the outlet pipe 621 along a fourth air flow GF4 directed obliquely upward, and then flows to the downstream side of the first branching flow passage 210 through the outlet pipe 621. The air contained in the ink in each of the extended spaces 671 to 674 inside the first conduit section 105 is thus collected into the outlet pipe 621 and discharged to the outside of the first conduit section 105 without stagnating on the partitions.

In the present embodiment, the lower inclined surfaces 646, 656, 666 are formed on the lower surface side of the respective partitions (lower partition 641, intermediate partition 651, and upper partition 661) so as to be inclined upward from the through-hole portion of each partition toward the outer periphery of each partition. A gap communicating with adjacent extended spaces through the partition is formed between the outer periphery of each partition and the side portion of the expanded pipe (lower expanded pipe 612 and upper expanded pipe 622). The upper base inclined surface 628 is formed on the lower surface side of the upper base of the upper expanded pipe 622, which is connected to the outlet pipe 621, so as to be inclined upward from the side portion of the upper expanded pipe 622 toward the outlet pipe 621. As described above, the air contained in the ink in each of the extended spaces 671 to 674 inside the first conduit section 105 is thus collected into the outlet pipe 621 and discharged to the outside of the first conduit section 105 without stagnating on the partitions. Therefore, upon execution of an ink filling operation for the printing head 21 and the circulation liquid channel, air hardly remains inside the conduit sections (first to third conduit sections 105 to 107), making it possible to avoid air (gas) from stagnating inside the conduit sections. Furthermore, by facilitating the evaporation of the water content of the ink at the interface between the ink and the air stagnating inside the conduit sections, precipitation of the components contained in the ink can be suppressed. By facilitating the evaporation of the water content of the ink at the interface between the ink and the air stagnating inside the conduit sections, the ink can be suppressed from drying out and solidifying.

### Precipitation of Ink Components Inside Conduit Section

Next, precipitation of ink components inside the first conduit section 105 will be described. Hereinafter, ink components prone to precipitation will be referred to as “precipitating components". Examples of ink components prone to precipitation (precipitating components) include ink components with a high specific gravity (specifically, titanium oxide contained in pigments or white ink) and the like.

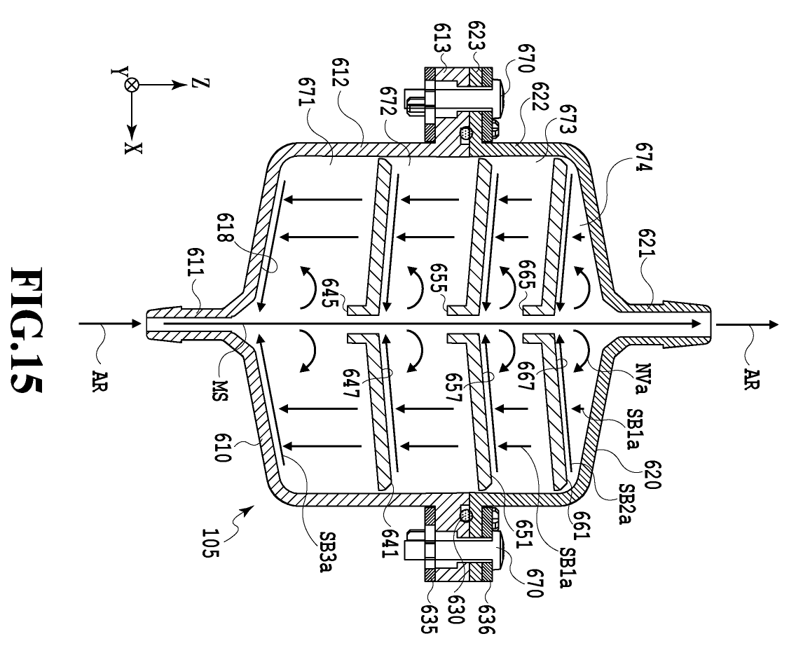

FIG. 15 is an explanatory diagram for explaining the precipitation of ink components inside the first conduit section 105. As shown in FIG. 15, an upper inclined surface 667 is formed on the upper surface side of the upper partition 661 so as to be inclined downward from the outer periphery of the upper partition 661 toward the upper through-hole portion 665. This allows the precipitating components of ink in the fourth extended space 674 to move toward the upper through-hole portion 665 along the upper inclined surface 667 of the upper partition 661.

An upper inclined surface 657 is formed on the upper surface side of the intermediate partition 651 so as to be inclined downward from the outer periphery of the intermediate partition 651 toward the intermediate through-hole portion 655. This allows the precipitating components of ink in the third extended space 673 to move toward the intermediate through-hole portion 655 along the upper inclined surface 657 of the intermediate partition 651.

An upper inclined surface 647 is formed on the upper surface side of the lower partition 641 so as to be inclined downward from the outer periphery of the lower partition 641 toward the lower through-hole portion 645. This allows the precipitating components of ink in the second extended space 672 to move toward the lower through-hole portion 645 along the upper inclined surface 647 of the lower partition 641.

A lower base inclined surface 618 is also formed on the upper surface side of the lower base of the lower expanded pipe 612, which connects to the inlet pipe 611, so as to be inclined downward from the side portion of the lower expanded pipe 612 toward the inlet pipe 611. This allows the precipitating components of ink in the first extended space 671 to move toward the outlet pipe 621 along the upper base inclined surface 628 of the upper expanded pipe 622.

The precipitating components of ink in the second to fourth extended spaces 672 to 674 precipitate on the upper inclined surfaces 647, 657, and 667 of the respective partitions (lower partition 641, intermediate partition 651, and upper partition 661) along a first precipitating component flow SB1a directed vertically downward. The upper inclined surfaces 647, 657, and 667 of the respective partitions are inclined downward from the outer periphery of each partition toward the through-hole portion of each partition. Therefore, the precipitating components of ink that reach the upper inclined surfaces 647, 657, and 667 of the respective partitions gently slide down toward the through-hole portion of each partition along a second precipitating component flow SB2a directed obliquely downward. Furthermore, the precipitating components of ink in the first extended space 671 precipitate on the lower base inclined surface 618 of the lower expanded pipe 612 along the first precipitating component flow SB1a directed vertically downward. The lower base inclined surface 618 of the lower expanded pipe 612 is inclined downward from the side portion of the lower expanded pipe 612 toward the inlet pipe 611. Therefore, the precipitating components of ink that reach the lower base inclined surface 618 of the lower expanded pipe 612 gently slide down toward the inlet pipe 611 along a third precipitating component flow SB3a directed obliquely downward. The precipitating components of ink that reach the through-hole portion of each partition or the vicinity of the inlet pipe 611 are stirred upward by an ink flow NVa that is entrained in the ink main stream MS. Such stirring of the precipitating components of ink in each extended space can suppress the accumulation of precipitate inside the first conduit section 105.

In the present embodiment, the upper inclined surfaces 647, 657, and 667 are formed on the upper surface of each of the partitions (lower partition 641, intermediate partition 651, and upper partition 661) so as to be inclined downward from the outer periphery of each partition toward the through-hole portion of each partition. The lower base inclined surface 618 is also formed on the upper surface side of the lower base of the lower expanded pipe 612, which connects to the inlet pipe 611, so as to be inclined downward from the side portion of the lower expanded pipe 612 toward the inlet pipe 611. As described above, the precipitating components of ink in each extended space are thus stirred, thus making it possible to suppress the accumulation of precipitate inside the conduit sections (first conduit section 105, second conduit section 106, and third conduit section 107).

The same effect can also be achieved in a case where the ink flows from the upper side to the lower side in the vertical direction. For example, in the third conduit section 107, the ink may flow from the outlet pipe 621 on the upper side to the inlet pipe 611 on the lower side in the vertical direction.

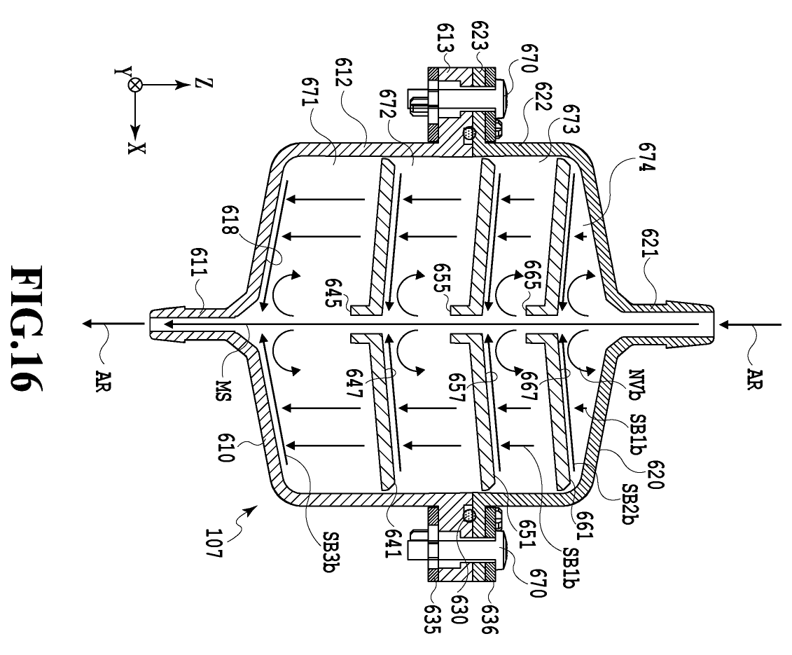

FIG. 16 is an explanatory diagram for explaining the precipitation of ink components inside the third conduit section 107 in a case where the ink flows from the outlet pipe 621 to the inlet pipe 611. The precipitating components of ink in the second to fourth extended spaces 672 to 674 precipitate on the upper inclined surfaces 647, 657, and 667 of the respective partitions (lower partition 641, intermediate partition 651, and upper partition 661) along the first precipitating component flow SB1b directed vertically downward. The precipitating components of ink that reach the upper inclined surfaces 647, 657, and 667 of the respective partitions gently slide down toward the through-hole portion of each partition along the second precipitating component flow SB2b directed obliquely downward. The precipitating components of ink in the first extended space 671 precipitate on the lower base inclined surface 618 of the lower expanded pipe 612 along the first precipitating component flow SB1b directed vertically downward. The precipitating components of ink that reach the lower base inclined surface 618 of the lower expanded pipe 612 gently slide down toward the outlet pipe (inlet pipe 611) along the third precipitating component flow SB3b directed obliquely downward. The precipitating components of ink that reach the through-hole portion of each partition or the vicinity of the outlet pipe (inlet pipe 611) are stirred by an ink flow NVb that is entrained in the ink main stream MS, so as to be back up away from the through-hole portion of each partition or the outlet pipe (inlet pipe 611). In this case, again, the precipitating components of ink in each extended space are stirred, thus making it possible to suppress the accumulation of precipitate inside the first conduit section 105.

As described above, according to the first embodiment, the pulsation of ink (liquid) supplied to the printing head 21 can be suppressed. For example, in the present embodiment, the lower through-hole portion 645, the intermediate through-hole portion 655, and the upper through-hole portion 665 protrude toward the upstream side of the lower expanded pipe 612 and the upper expanded pipe 622. This reduces the generation of turbulence in the ink main stream MS as described above, thus making it possible to reduce the ink pulsation.

Furthermore, in the present embodiment, the cross section of the internal space of the inlet pipe 611 as seen from the upstream side of the first conduit section 105 overlaps with the cross sections of the internal spaces of the lower through-hole portion 645, the intermediate through-hole portion 655, and the upper through-hole portion 665. The cross sections of the internal spaces of the lower through-hole portion 645, the intermediate through-hole portion 655, and the upper through-hole portion 665 as seen from the upstream side of the first conduit section 105 overlap with the cross section of the internal space of the outlet pipe 621. This can avoid the ink main stream MS from becoming turbulent as described above, thus reducing the ink pulsation. Accordingly, the pulsation of ink supplied to the printing head 21 can be suppressed.

During the ink filling operation, the control unit 500 controls the choke valve 118 to close the supply channel 200 and, with the recovery unit 160 applying negative pressure, controls the choke valve 118 to open the supply channel 200, allowing ink to flow through the supply channel 200. As a result, during so-called choke suction, ink sent from the first pump 101 and the second pump 102 is filled in the extended spaces inside the lower expanded pipe 612 and the upper expanded pipe 622, which have larger cross-section areas than the inlet pipe 611 and the outlet pipe 621 in the conduit section. This can suppress rapid ink filling in the supply channel 200, thus making it possible to avoid the supply channel 200 from being filled with the ink past the choke valve 118. Furthermore, upon execution of the ink filling operation using the choke suction, air bubbles can be suppressed from entering the inside of the printing head 21, thereby suppressing the formation of sticking matter by the air bubbles entering the inside of the printing head 21.

### Second Embodiment

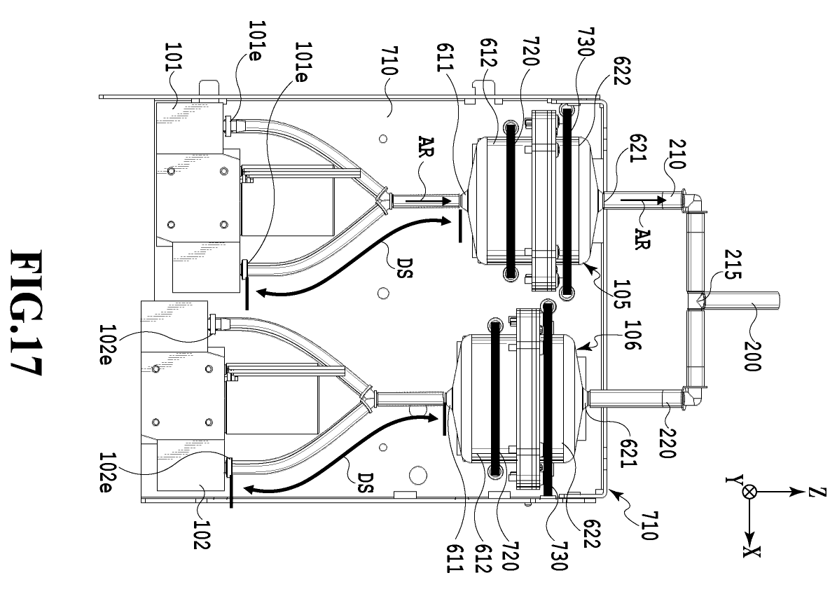

Next, a second embodiment of a printing apparatus will be described. The individual members in the second embodiment are the same as those in the first embodiment described above, and will therefore be denoted by the same reference numerals as those in the first embodiment. FIG. 17 is a side view of a holding unit 700. A circulation unit 100 (not shown in FIG. 17) of the second embodiment further includes the holding unit 700. The holding unit 700 holds the first pump 101, the second pump 102, the first conduit section 105, and the second conduit section 106.

In the second embodiment, two-cylinder pumps are used as the first pump 101 and the second pump 102. The first pump 101 in the second embodiment has two outlet connection parts 101e. The flow paths extending from the two outlet connection parts 101e in the first branching flow passage 210 merge at a position above the first pump 101 and are connected to the inlet pipe 611 of the first conduit section 105. The second pump 102 in the second embodiment has two outlet connection parts 102e. The flow paths extending from the two outlet connection parts 102e in the second branching flow passage 220 merge at a position above the second pump 102 and are connected to the inlet pipe 611 of the second conduit section 106. The junction 215 of the first branching flow passage 210 and the second branching flow passage 220 is located between the printing head 21 and the first branching flow passage 210 and the second branching flow passage 220 in the supply channel 200.

### Arrangement of Pump and Conduit Section

The outlet connection part 101e of the first pump 101 (the outlet connection part 102e of the second pump 102) has a length of, for example, about 12 cm. The inlet pipe 611 of the first conduit section 105 (the inlet pipe 611 of the second conduit section 106) has a length of, for example, about 12 cm. The length of a tube connected to the outlet connection part 101e of the first pump 101 (the outlet connection part 102e of the second pump 102) and the inlet pipe 611 of the first conduit section 105 (the inlet pipe 611 of the second conduit section 106) is, for example, about 30 cm. Therefore, the distance DS between the first pump 101 (the second pump 102) and the first conduit section 105 (the second conduit section 106) in the supply channel 200 is, for example, about 6 cm.

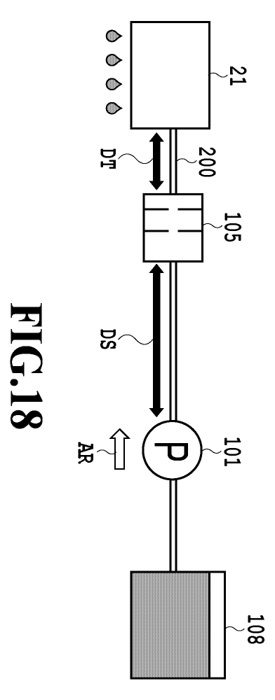

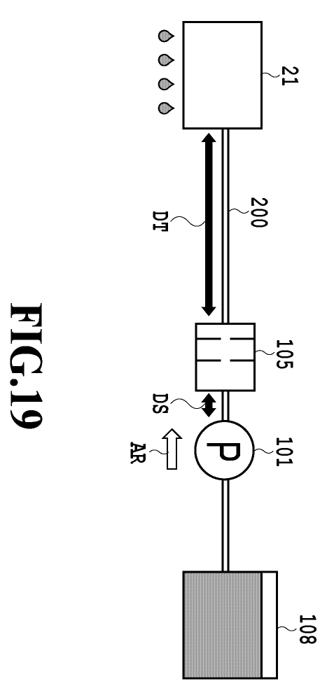

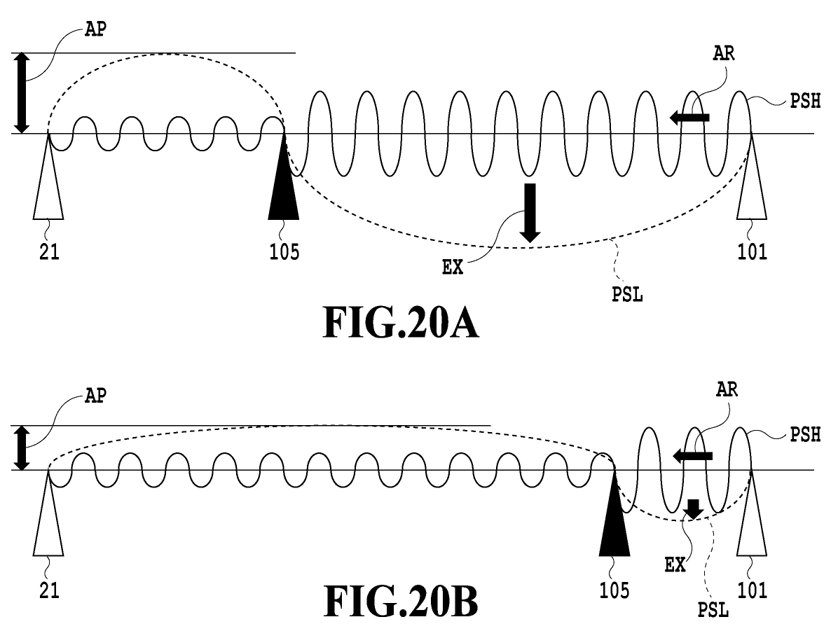

FIG. 18 is a schematic diagram showing a state where the first conduit section 105 is located away from the first pump 101. FIG. 19 is a schematic diagram showing a state where the first conduit section 105 is located near the first pump 101. FIGS. 20A and 20B are explanatory diagrams showing the effect of the positioning of the conduit section on pulsation. FIGS. 20A and 20B also show how the amplitude component of ink pulsation generated by the pump is attenuated as the pulsation reaches the printing head through the conduit section. FIG. 20A is an explanatory diagram showing the effect of the first conduit section 105 located away from the first pump 101 on the pulsation. FIG. 20B is an explanatory diagram showing the effect of the first conduit section 105 located near the first pump 101 on the pulsation.

As shown in FIGS. 18 and 19, the first pump 101 sends ink stored in the buffer tank 108 to the printing head 21 through the first conduit section 105 disposed in the supply channel 200 (first branching flow passage 210). Here, description will be given of a case where the distance DS between the first pump 101 and the first conduit section 105 in the supply channel 200 is longer than the distance DT between the first conduit section 105 in the supply channel 200 and the printing head 21, as shown in FIGS. 18 and 20A. As shown in FIG. 20A, the ink pulsation generated by the first pump 101 is a small-amplitude, high-frequency pulsation PSH, which may interfere with or resonate with vibrations propagating from other units in the flow path en route to the first conduit section 105. If the frequency of the high-frequency pulsation PSH changes due to interference or resonance, the frequency of the high-frequency pulsation PSH may match the natural frequency of another component. The frequency of the high-frequency pulsation PSH is about 30 Hz to 40 Hz. The tube used in the supply channel 200 as an example of another component has the natural frequency of about 0.3 Hz. A pulsation excitation phenomenon EX caused by the frequency of the high-frequency pulsation PSH matching the natural frequency of another component may cause the high-frequency pulsation PSH to change into a low-frequency pulsation PSL with a larger amplitude.

When pressure pulsation occurs in the ink supplied to the printing head 21, the amplitude component of the pulsation indicates the amount of change in ink pressure. In this case, the amplitude component of the pulsation can make the ink ejection by the printing head 21 unstable. For this reason, it is generally better for the amplitude component of the pulsation to be small. In the example shown in FIG. 20A, since the first conduit section 105 is located away from the first pump 101, a large-amplitude low-frequency pulsation PSL passes through the first conduit section 105 on the downstream side of the supply channel 200 (first branching flow passage 210). Therefore, even if the amplitude component of the pulsation (high-frequency pulsation PSH) is attenuated in the first conduit section 105, it is difficult to suppress the amplitude AP of the low-frequency pulsation PSL to an amplitude that does not affect the ink ejection by the printing head 21.

Next, as shown in FIGS. 19 and 20B, description will be given of a case where the distance DS between the first pump 101 and the first conduit section 105 in the supply channel 200 is shorter than the distance DT between the first conduit section 105 in the supply channel 200 and the printing head 21. In the example shown in FIG. 20B, since the first conduit section 105 is located near the first pump 101, even if the pulsation excitation phenomenon EX occurs, the low-frequency pulsation PSL before its amplitude increases passes through the first conduit section 105 on the downstream side of the supply channel 200. As a result, the amplitude component of the pulsation (high-frequency pulsation PSH) is attenuated in the first conduit section 105, and the amplitude AP of the low-frequency pulsation PSL is suppressed to an amplitude that does not affect the ink ejection by the printing head 21. As shown in FIG. 17, even if the supply channel 200 (first branching flow passage 210) is curved, the amplitude AP of the low-frequency pulsation PSL can be suppressed.

Accordingly, the ink pulsation can be effectively reduced by making the distance DS between the first pump 101 and the first conduit section 105 in the supply channel 200 shorter than the distance DT between the first conduit section 105 in the supply channel 200 and the printing head 21. Similarly, the ink pulsation can be effectively reduced by making the distance between the second pump 102 and the second conduit section 106 in the supply channel 200 shorter than the distance between the second conduit section 106 in the supply channel 200 and the printing head 21. The distance DS between the first pump 101 and the first conduit section 105 may be less than or equal to 0.60 times the distance DT between the first conduit section 105 and the printing head 21, or may be more than or equal to 0.02 times the distance DT between the first conduit section 105 and the printing head 21. The distance between the second pump 102 and the second conduit section 106 may be less than or equal to 0.60 times the distance between the second conduit section 106 and the printing head 21, or may be more than or equal to 0.02 times the distance between the second conduit section 106 and the printing head 21.

The first conduit section 105 is disposed between the first pump 101 and the junction 215 in the first branching flow passage 210 of the supply channel 200. The second conduit section 106 is disposed between the second pump 102 and the junction 215 in the second branching flow passage 220 of the supply channel 200. For example, if two pumps send ink in parallel in opposite phases, while one of the two pumps does not send any ink, the other pump sends the ink. Therefore, there is a possibility that the ink flows backward (gets pushed in) in one of the two branching flow passages, to which no ink is sent. As a result, in a case where the pump that is not sending ink next sends the ink, the pump needs to send the ink upstream while pushing back the ink flowing backward, resulting in an unstable ink flow rate. Furthermore, such an unstable ink flow rate occurs even if the phases of the two pumps are not completely opposite.

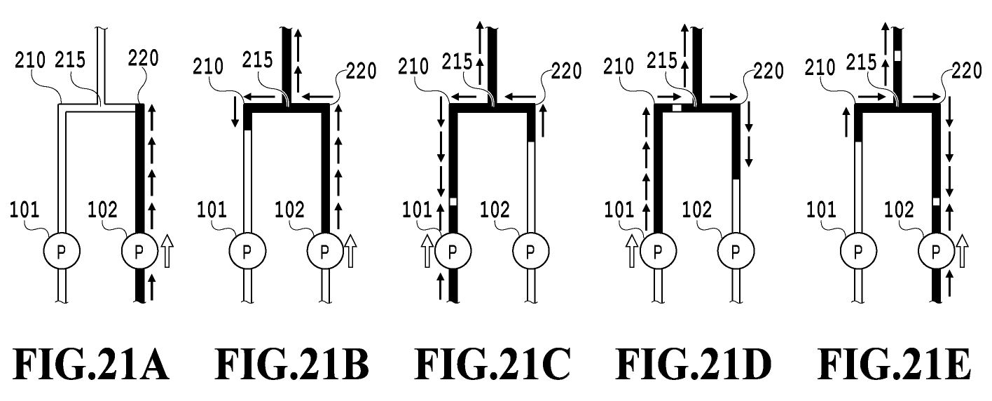

FIGS. 21A to 21E are schematic diagrams showing a flow of ink sent from the two pumps (first pump 101 and second pump 102) in opposite phases. FIG. 21A is a schematic diagram showing ink sent from the second pump 102 in the second branching flow passage 220. FIG. 21B is a schematic diagram showing a state where ink flowing through the second branching flow passage 220 flows backward in the first branching flow passage 210. FIG. 21C is a schematic diagram showing a state where ink flowing backward in the first branching flow passage 210 interferes with ink sent from the first pump 101. FIG. 21D is a schematic diagram showing a state where ink flowing through the first branching flow passage 210 flows backward in the second branching flow passage 220. FIG. 21E is a schematic diagram showing a state where ink flowing backward in the second branching flow passage 220 interferes with ink sent from the second pump 102. In FIGS. 21A to 21E, black arrows indicate the flow of ink, while white arrows indicate the direction of ink flow from the pump that is sending the ink.

In the order of FIGS. 21A to 21E, the phases of the two pumps change between the phase upon sending ink by the second pump 102 and the phase upon sending ink by the first pump 101. As shown in FIG. 21A, the ink sent from the second pump 102 flows through the second branching flow passage 220. As shown in FIG. 21B, the ink sent from the second pump 102 flows downstream of the supply channel 200 through the junction 215 after flowing through the second branching flow passage 220. In this event, some of the ink that reaches the junction 215 from the second branching flow passage 220 flows backward in the first branching flow passage 210. As shown in FIG. 21C, the ink sent from the first pump 101 interferes with the ink flowing backward in the first branching flow passage 210. As shown in FIG. 21D, the ink sent from the first pump 101 pushes back the ink flowing backward in the first branching flow passage 210 and flows downstream of the supply channel 200 through the junction 215. In this event, some of the ink that reaches the junction 215 from the first branching flow passage 210 flows backward in the second branching flow passage 220. As shown in FIG. 21E, the ink sent next from the second pump 102 interferes with the ink flowing backward in the second branching flow passage 220. As shown in FIGS. 21A to 21E, in the case where the two pumps send the ink in parallel in opposite phases, the ink flow rate becomes unstable.

By disposing the first conduit section 105 between the first pump 101 and the junction 215 in the first branching flow passage 210, the momentum of the ink flowing backward in the first branching flow passage 210 can be attenuated by the first conduit section 105. By disposing the second conduit section 106 between the second pump 102 and the junction 215 in the second branching flow passage 220, the momentum of the ink flowing backward in the second branching flow passage 220 can be attenuated by the second conduit section 106. This makes it possible to stabilize the flow rates of the ink sent from the first pump 101 and the second pump 102.

On the other hand, in a case where the two pumps send ink in parallel in the same phase, the ink pulsations generated by the two pumps are mutually excited at the junction 215, which may affect the ink ejection by the printing head 21. By disposing the first conduit section 105 between the first pump 101 and the junction 215 in the first branching flow passage 210, the ink pulsation generated by the first pump 101 can be reduced by the first conduit section 105. By disposing the second conduit section 106 between the second pump 102 and the junction 215 in the second branching flow passage 220, ink pulsation generated by the second pump 102 can be reduced by the second conduit section 106. This effectively suppresses the amplitude of the pulsation generated at the junction 215 to an amplitude that does not affect the ink ejection by the printing head 21, thus making it possible to effectively reduce the ink pulsation.

### Configuration of Holding Unit

As shown in FIG. 17, the holding unit 700 includes a holding member 710, a first fixing member 720, and a second fixing member 730. The holding member 710 is a member for holding the first pump 101 and the second pump 102. The holding member 710 is also a member for holding the first conduit section 105 and the second conduit section 106. The first fixing member 720 is a fixing member for fixing the upstream side (lower expanded pipe 612) of each of the first conduit section 105 and the second conduit section 106 to the holding member 710. The second fixing member 730 is a downstream fixing member for fixing the downstream side (upper expanded pipe 622) of each of the first conduit section 105 and the second conduit section 106 to the holding member 710.

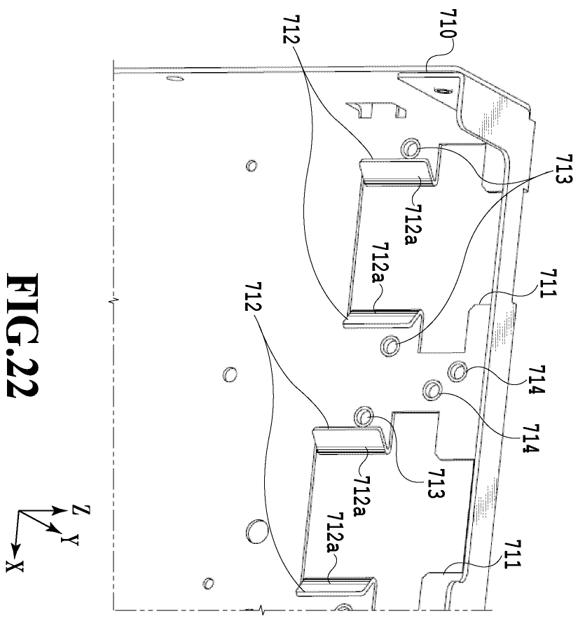

FIG. 22 is a perspective view showing a part of the holding member 710. As shown in FIG. 22, the holding member 710 is formed in a plate shape using sheet metal. The holding member 710 has two relief holes 711, two sets of abutment portions 712, two sets of first mounting holes 713, and two sets of second mounting holes 714. The two relief holes 711 are formed side by side on the left and right in the upper part of the holding member 710 so as to match the positions of the first conduit section 105 and the second conduit section 106. Each relief hole 711 is formed so as to come into contact with the abutment portion 712. Portions of the lower expanded pipe 612 and the upper expanded pipe 622 (for example, the lower flange portion 613 and the upper flange portion 623) are inserted into the relief holes 711 so that the first conduit section 105 (and the second conduit section 106) does not abut against the holding member 710. This suppresses the first conduit section 105 (and the second conduit section 106) from vibrating by contacting other portions of the holding member 710 before the abutment portion 712 and becoming unstable.

The abutment portions 712 contact the side portions of the lower expanded pipe 612 from the left and right, thereby stabilizing the posture of the first conduit section 105 (and the second conduit section 106). The abutment portions 712 have abutting surfaces 712a that are inclined so as to come into contact with the side surfaces of the cylindrical lower expanded pipe 612. The first mounting holes 713 are formed in portions of the holding member 710 adjacent to the left and right of the abutment portions 712. The first fixing member 720 is inserted into the first mounting holes 713. The second mounting holes 714 are formed in portions of the holding member 710 adjacent to the left and right of the relief holes 711. The second mounting holes 714 are positioned above the first mounting holes 713 on the holding member 710. The second fixing member 730 is inserted into the second mounting holes 714.

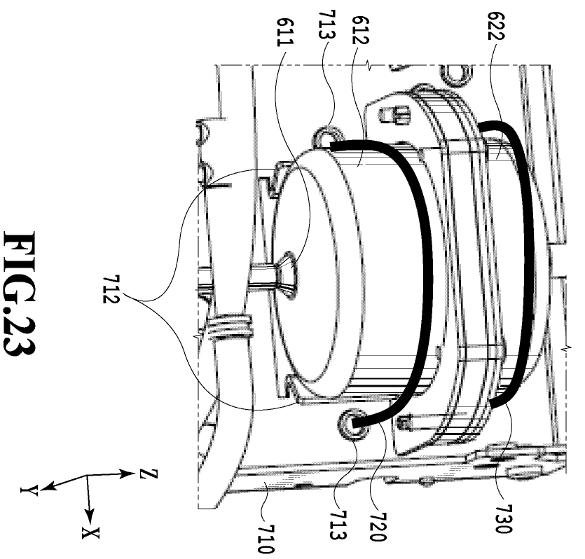

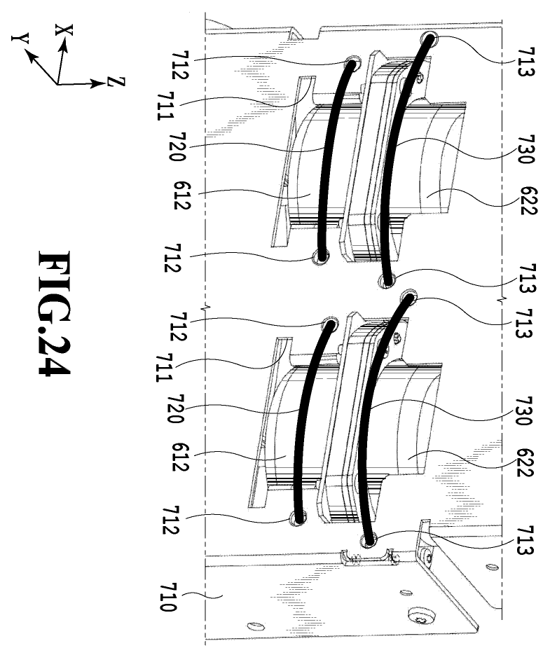

FIG. 23 is a perspective view of the conduit section fixed to the holding member 710, as seen from the front side. FIG. 24 is a perspective view of the conduit section fixed to the holding member 710, as seen from the back side. To save space, the lower expanded pipe 612 and the upper expanded pipe 622 are formed in a cylindrical shape to match the shape of the internal space (extended space). With the lower expanded pipe 612 abutting on the abutment portions 712, the first fixing member 720 inserted through the first mounting holes 713 covers and presses against the side surface of the lower expanded pipe 612, thereby stabilizing the posture of the lower expanded pipe 612 and the upper expanded pipe 622 (conduit section). The first fixing member 720 is formed using a resin band-like member such as a zip tie, for example. As a result, the first fixing member 720 deforms so as to match the shape of the side surface of the lower expanded pipe 612, thereby stably fixing the lower expanded pipe 612 to the holding member 710.

With the upper expanded pipe 622 not in contact with the abutment portions 712, the second fixing member 730 inserted into the second mounting holes 714 presses against the side surface of the upper expanded pipe 622 from the front and back. As with the first fixing member 720, the second fixing member 730 is formed using a resin band-like member. As a result, the second fixing member 730 deforms so as to match the shape of the side surface of the upper expanded pipe 622, thereby stably fixing the upper expanded pipe 622 to the holding member 710. Note that the material of the first fixing member 720 and the second fixing member 730 is not limited to resin, and may contain other substances such as metal.

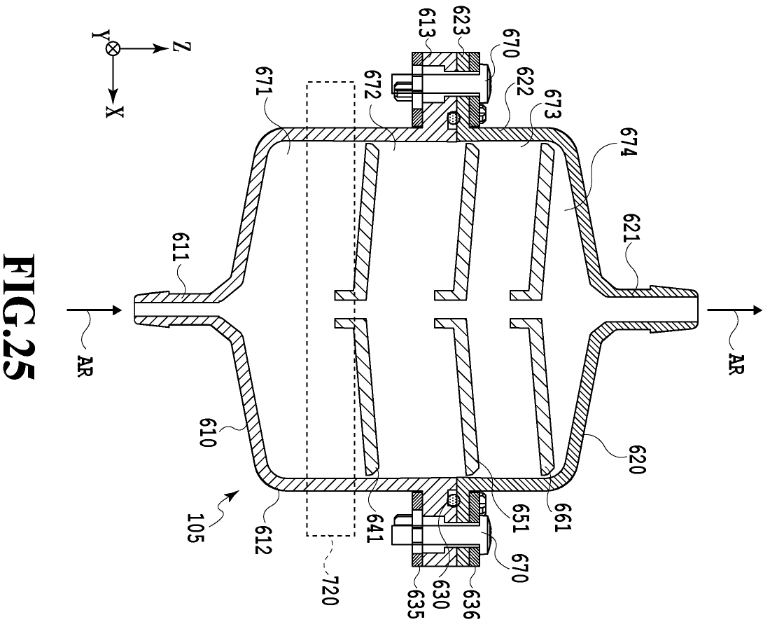

FIG. 25 is an explanatory diagram showing a positional relationship between the first conduit section 105 and the first fixing member 720. As shown in FIG. 25, the first fixing member 720 fixes the portion of the lower expanded pipe 612 where the first extended space 671 on the most upstream side is located to the holding member 710. As described above, the first pump 101 (second pump 102), which is the vibration source, is disposed on the upstream side of the first conduit section 105 (second conduit section 106) in the first branching flow passage 210 (second branching flow passage 220). With the first fixing member 720 fixing the portion of the lower expanded pipe 612 where the first extended space 671 on the most upstream side is located, that is, the portion of the lower expanded pipe 612 closest to the pump, the vibration of the first conduit section 105 (second conduit section 106) can be effectively suppressed.

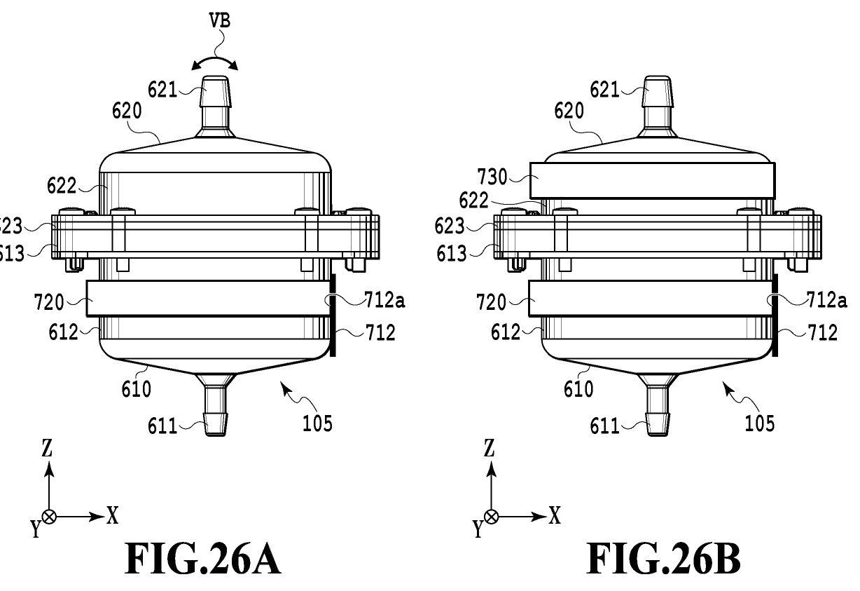

FIGS. 26A and 26B are side views showing the first conduit section 105 fixed by each fixing member. FIG. 26A is a side view showing the first conduit section 105 fixed by the first fixing member 720. FIG. 26B is a side view showing the first conduit section 105 fixed by the first fixing member 720 and the second fixing member 730. As shown in FIG. 26A, the first conduit section 105 (lower expanded pipe 612) may be fixed to the holding member 710 using only the first fixing member 720 and the abutment portion 712. However, as mentioned above, the holding member 710 has the relief holes 711 formed therein, through which the lower expanded pipe 612 and the upper expanded pipe 622 are partially inserted. For this reason, with the lower expanded pipe 612 fixed using only the first fixing member 720 and the abutment portion 712, vibration VB may occur in a portion of the first conduit section 105 on the downstream side (outlet pipe 621), centered around the abutment surface 712a in contact with the side surface of the lower expanded pipe 612.

As shown in FIG. 26B, it is preferable that the first conduit section 105 is fixed to the holding member 710 using the second fixing member 730 in addition to the first fixing member 720 and the abutment portion 712. The second fixing member 730 fixes the portion of the upper expanded pipe 622 where the extended space (third extended space 673) on the downstream side is located to the holding member 710. This makes it possible to suppress the vibration in the portion of the first conduit section 105 on the downstream side (outlet pipe 621).

As described above, according to the second embodiment, as in the first embodiment, pulsation of ink (liquid) supplied to the printing head 21 can be suppressed. In the second embodiment, the first fixing member 720 fixes the portion of the lower expanded pipe 612 where the first extended space 671 on the most upstream side is located to the holding member 710. As mentioned above, with the first fixing member 720 fixing the portion of the lower expanded pipe 612 closest to the pump, the vibration of the first conduit section 105 (second conduit section 106) can be effectively suppressed.

In the first and second embodiments described above, the supply channel 200 in the circulation liquid channel has, but not limited to, the first branching flow passage 210 and the second branching flow passage 220. For example, the supply channel 200 may have three or more branching flow passages. In this case, each of the plurality of branching flow passages is provided with a pump similar to the first pump 101 and the second pump 102, and a conduit section similar to the first conduit section 105 and the second conduit section 106.

In the first and second embodiments described above, the first conduit section 105, the second conduit section 106, and the third conduit section 107 are disposed, but not limited to, along the direction in which the ink flows from the lower side to the upper side in the vertical direction. For example, the first conduit section 105, the second conduit section 106, and the third conduit section 107 may be disposed along the direction in which the ink flows from the lower side to the upper side in the direction inclined relative to the vertical direction.

### Third Embodiment

Next, a third embodiment of a printing apparatus will be described. The individual members in the third embodiment are the same as those in the first embodiment described above, and will therefore be denoted by the same reference numerals as those in the first embodiment.

### Configuration of Circulation Unit

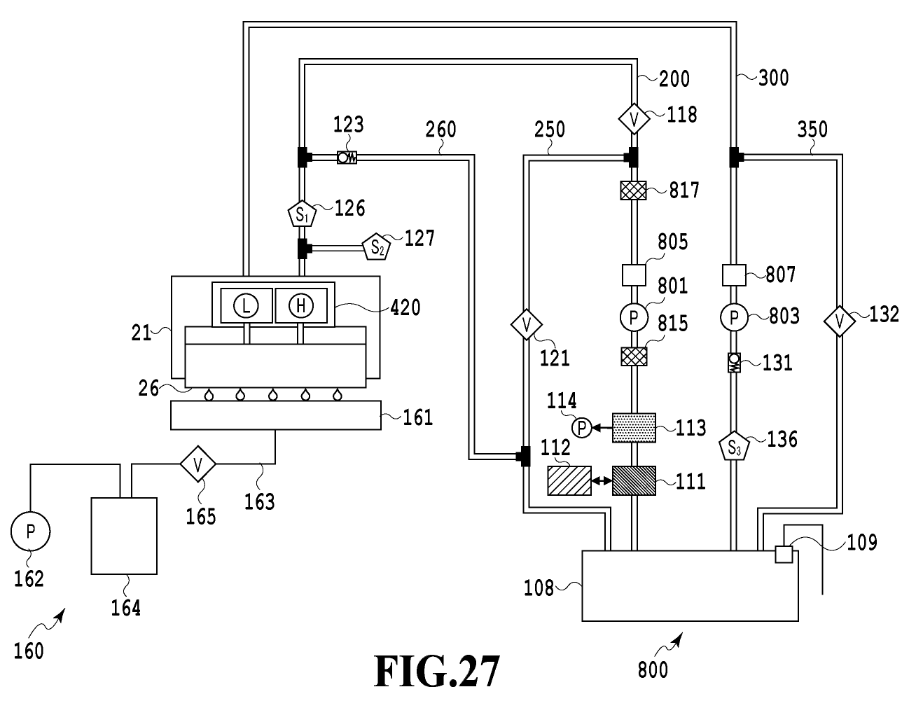

FIG. 27 is a schematic diagram showing a circulation liquid channel including a circulation unit 800 of the third embodiment. The circulation unit 800 of the third embodiment includes a supply pump 801, a collection pump 803, a supply-side conduit section 805, a collection-side conduit section 807, and a buffer tank 108. The circulation unit 800 also includes a heat exchanger 111, a deaeration module 113, a first supply-side filter 815, a second supply-side filter 817, and a choke valve 118. The circulation unit 800 also includes a first solenoid valve 121, a relief valve 123, a check valve 131, and a second solenoid valve 132. The components of the circulation unit 800 may be connected directly or through resin or metal piping. The first solenoid valve 121, the relief valve 123, the check valve 131, and the second solenoid valve 132 have the same configurations as those of the first solenoid valve 121, the relief valve 123, the check valve 131, and the second solenoid valve 132 of the first embodiment.

The buffer tank 108 has the same configuration as that of the buffer tank 108 of the first embodiment. As in the first embodiment, a supply channel 200, a supply-side air communicating channel 250, a relief channel 260, a collecting channel 300, and a collection-side air communicating channel 350 are connected to the buffer tank 108. The supply channel 200, the supply-side air communicating channel 250, the relief channel 260, the collecting channel 300, and the collection-side air communicating channel 350 form a circulation liquid channel for supplying and circulating ink to the printing head 21.

The supply channel 200 of the third embodiment does not have the first branching flow passage 210 and the second branching flow passage 220 of the first embodiment. In the supply channel 200, a heat exchanger 111, a deaeration module 113, a first supply-side filter 815, a supply pump 801, a supply-side conduit section 805, a second supply-side filter 817, and a choke valve 118 are disposed in this order from the buffer tank 108 side.

The heat exchanger 111 and a temperature regulator 112 have the same configurations as those of the heat exchanger 111 and the temperature regulator 112 of the first embodiment. The deaeration module 113 and a pressure-reducing pump 114 have the same configurations as those of the deaeration module 113 and the pressure-reducing pump 114 of the first embodiment. The first supply-side filter 815 has the same configuration as that of the first filter 115 of the first embodiment. The second supply-side filter 817 has the same configuration as that of the third filter 117 of the first embodiment.

The supply pump 801 has the same configuration as that of the first pump 101 of the first embodiment. The supply pump 801 sends ink stored in the buffer tank 108 to the printing head 21 through the supply channel 200.

The supply-side conduit section 805 has the same configuration as that of the first conduit section 105 of the first embodiment. The cross-section area of the internal space of the supply-side conduit section 805 is larger than the cross-section area of the supply channel 200. This allows the supply-side conduit section 805 to reduce pulsation generated as the supply pump 801 sends the ink.

The choke valve 118 has the same configuration as that of the choke valve 118 of the first embodiment. The choke valve 118 is disposed in a portion of the supply channel 200 between the supply-side conduit section 805 and the printing head 21. As in the first embodiment, a temperature sensor 126 and a pressure sensor 127 are disposed in a portion of the supply channel 200 between the choke valve 118 and the printing head 21.

The supply-side air communicating channel 250 and the relief channel 260 have the same configurations as those of the supply-side air communicating channel 250 and the relief channel 260 of the first embodiment. The supply-side air communicating channel 250 branches off from a portion of the supply channel 200 between the second supply-side filter 817 and the choke valve 118, and is connected to the buffer tank 108.

In the collecting channel 300, the collection-side conduit section 807, the collection pump 803, and the check valve 131 are disposed in this order from the printing head 21 side. The collection-side conduit section 807 has the same configuration as that of the third conduit section 107 of the first embodiment. The collection pump 803 has the same configuration as that of the third pump 103 of the first embodiment. As in the first embodiment, a flow rate sensor 136 is disposed in the collecting channel 300 between the check valve 131 and the buffer tank 108.

The collection-side air communicating channel 350 has the same configuration as that of the collection-side air communicating channel 350 of the first embodiment. The collection-side air communicating channel 350 branches off from a portion of the collecting channel 300 between the printing head 21 and the collection-side conduit section 807, and is connected to the buffer tank 108.

The configuration of the circulation unit 800 is not limited to that described in the present embodiment. For example, the circulation unit 800 does not have to have a filter or a check valve. The circulation unit 800 does not have to have a temperature sensor. The recovery unit 160 has the same configuration as that of the recovery unit 160 of the first embodiment.

### Configuration of Supply-Side Conduit Section

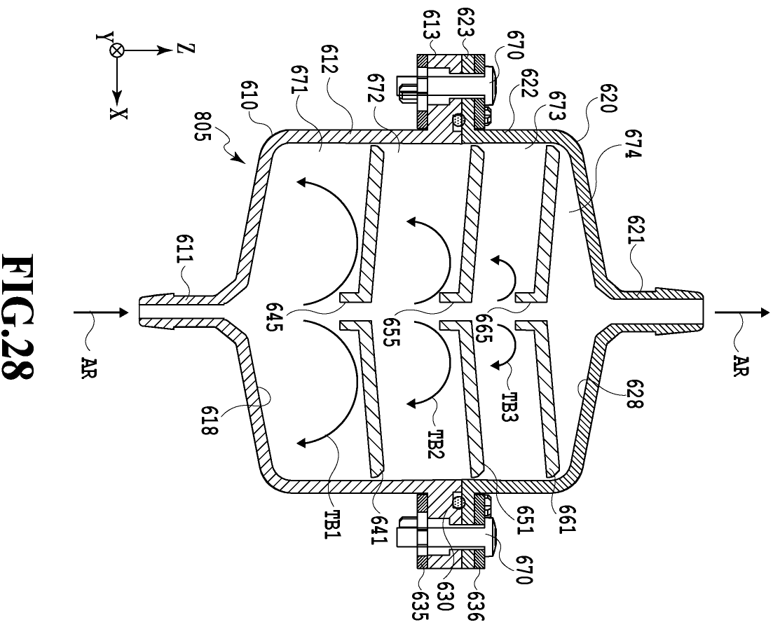

FIG. 28 is a sectional side view of the supply-side conduit section 805. As shown in FIG. 28, in the supply-side conduit section 805, a lower partition 641, an intermediate partition 651, and an upper partition 661 are disposed in this order from the upstream side. Inside the supply-side conduit section 805 (lower expanded pipe 612 and upper expanded pipe 622), a first extended space 671, a second extended space 672, a third extended space 673, and a fourth extended space 674 are formed in this order from the upstream side.

As in the first embodiment, ink send through the supply channel 200 by the supply pump 801 flows from the inlet pipe 611 into the supply-side conduit section 805. Inside the supply-side conduit section 805, the ink flows into the first extended space 671 through the inlet pipe 611. The ink flowing into the first extended space 671 flows into the second extended space 672 through the first extended space 671 and the lower through-hole portion 645. The ink flowing into the second extended space 672 flows into the third extended space 673 through the second extended space 672 and the intermediate through-hole portion 655. The ink flowing into the third extended space 673 flows into the fourth extended space 674 through the third extended space 673 and the upper through-hole portion 665. The ink flowing into the fourth extended space 674 flows to the downstream side of the supply channel 200 through the fourth extended space 674 and the outlet pipe 621.

As in the first embodiment, ink pulsation is reduced each time the ink passes through each of the extended spaces 671 to 674 and each of the through-hole portions (lower through-hole portion 645, intermediate through-hole portion 655, and upper through-hole portion 665). As the ink in the first extended space 671 passes through the lower through-hole portion 645, a relatively large first turbulence TB1 is generated in the first extended space 671. As the ink in the second extended space 672 passes through the intermediate through-hole portion 655, a second turbulence TB2 smaller than the first turbulence TB1 is generated in the second extended space 672. As the ink in the third extended space 673 passes through the upper through-hole portion 665, a third turbulence TB3 smaller than the second turbulence TB2 is generated in the third extended space 673.

Accordingly, the turbulence generated in the extended space decreases each time the ink passes through the through-hole portion on the downstream side. Therefore, even if the size (volume) of the extended space decreases toward the downstream side of the lower expanded pipe 612 and the upper expanded pipe 622, the effect of reducing pulsation hardly decreases. In the third embodiment, as in the first embodiment, the length of each extended space in the extending direction of the lower expanded pipe 612 and the upper expanded pipe 622 decreases toward the downstream side of the lower expanded pipe 612 and the upper expanded pipe 622. That is, the length of the expanded pipe (lower expanded pipe 612 and upper expanded pipe 622) in the extending direction of the expanded pipe in the extended space on the downstream side is shorter than the length of the expanded pipe in the extending direction in the extended space on the upstream side. This makes it possible to reduce the size (volume) of the extended space inside the supply-side conduit section 805 (collection-side conduit section 807) without impairing the effect of reducing the pulsation. Therefore, the supply-side conduit section 805 (collection-side conduit section 807) can be made smaller, and the installation space for the supply-side conduit section 805 (collection-side conduit section 807) can be reduced.

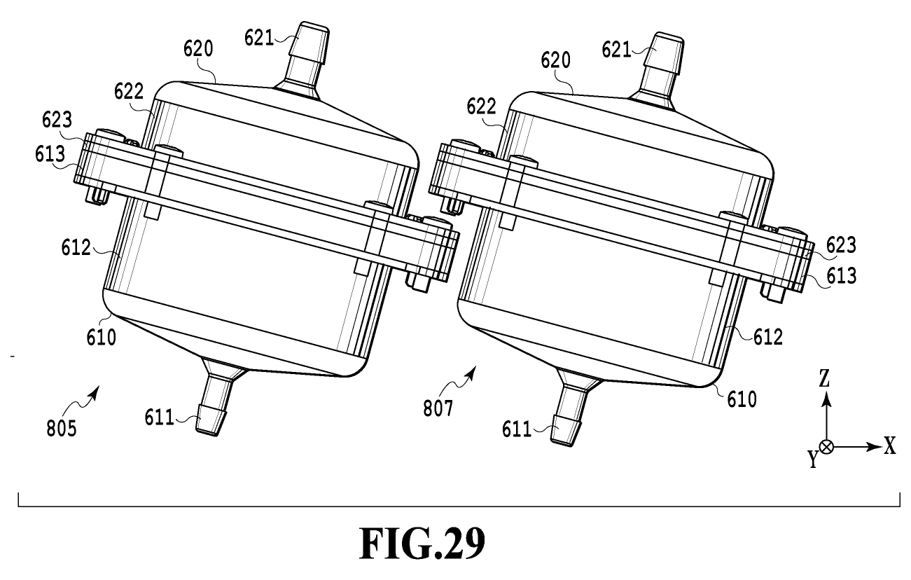

FIG. 29 is a side view of the supply-side conduit section 805 and the collection-side conduit section 807. As shown in FIG. 29, the supply-side conduit section 805 and the collection-side conduit section 807 are provided in parallel in the circulation liquid channels (supply channel 200 and collecting channel 300). The supply-side conduit section 805 and the collection-side conduit section 807 are disposed so that the lower flange portion 613 and the upper flange portion 623 partially overlap as seen from the upstream side of the supply-side conduit section 805 and the collection-side conduit section 807. This reduces the space between the supply-side conduit section 805 and the collection-side conduit section 807, making it possible to reduce the installation space for the supply-side conduit section 805 and the collection-side conduit section 807.

Furthermore, the extending directions of the supply-side conduit section 805 and the collection-side conduit section 807 (lower expanded pipe 612 and upper expanded pipe 622) are inclined with respect to the vertical direction (Z direction). This reduces the combined vertical and horizontal lengths of the supply-side conduit section 805 and the collection-side conduit section 807, thus making it possible to reduce the installation space for the supply-side conduit section 805 and the collection-side conduit section 807. The inlet pipe 611 is located below the lower expanded pipe 612 and allows the ink flowing through the circulation liquid channel (supply channel 200 or collecting channel 300) to flow obliquely upward. The outlet pipe 621 is located above the upper expanded pipe 622 and allows the ink flowing through the internal space (extended space) of the upper expanded pipe 622 to flow out obliquely upward.

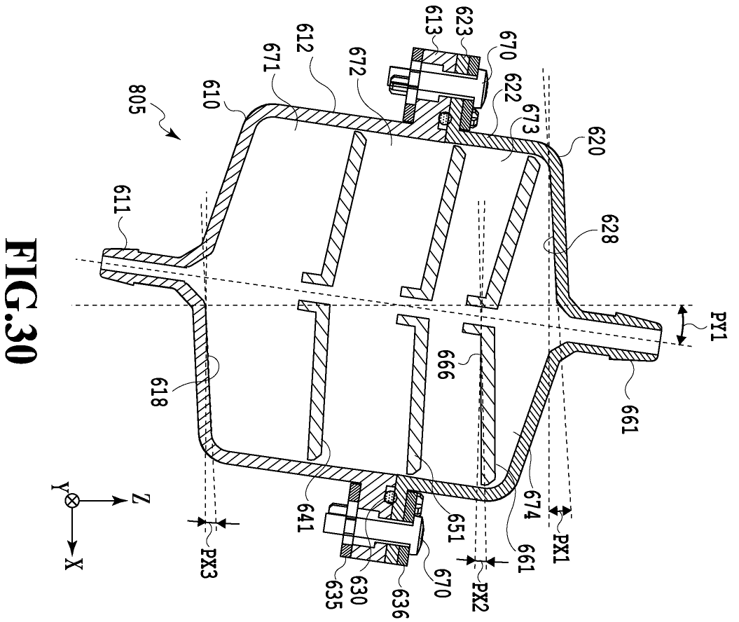

FIG. 30 is a sectional side view for explaining the inclination of the supply-side conduit section 805. As shown in FIG. 30, with PY1 being the inclination angle of the lower expanded pipe 612 and the upper expanded pipe 622 in the extending direction with respect to the vertical direction (Z direction), the upward inclination angle PX1 of the upper base inclined surface 628 of the upper expanded pipe 622 with respect to the horizontal plane is greater than 0 degrees. The upward inclination angle of the lower inclined surface of each partition with respect to the horizontal plane is also greater than 0 degrees. For example, the upward inclination angle PX2 of the lower inclined surface 666 of the upper partition 661 with respect to the horizontal plane is greater than 0 degrees. As a result, as in the first embodiment, air contained in the ink in each of the extended spaces 671 to 674 inside the supply-side conduit section 805 is collected into the outlet pipe 621 without stagnating on each partition and discharged to the outside of the supply-side conduit section 805. Therefore, upon execution of an ink filling operation for the printing head 21 and the circulation liquid channel, air hardly remains inside the conduit sections (supply-side conduit section 805 and collection-side conduit section 807), thus avoiding air (gas) from stagnating inside the conduit sections. The upward inclination angle PX1 of the upper base inclined surface 628 of the upper expanded pipe 622 with respect to the horizontal plane may be greater than or equal to 5 degrees, or may be smaller than or equal to 10 degrees. The upward inclination angle of the lower inclined surface of each partition with respect to the horizontal plane may be greater than or equal to 5 degrees, or may be smaller than or equal to 10 degrees.

Similarly, with PY1 being the inclination angle of the lower expanded pipe 612 and the upper expanded pipe 622 in the extending direction with respect to the vertical direction (Z direction), the upward inclination angle PX3 of the lower base inclined surface 618 of the lower expanded pipe 612 with respect to the horizontal plane is greater than 0 degrees. The upward inclination angle of the upper inclined surface of each partition with respect to the horizontal plane is also greater than 0 degrees. As a result, as in the first embodiment, the precipitating components of ink in the first extended space 671 are stirred, thus making it possible to suppress the accumulation of precipitate inside the conduit sections (supply-side conduit section 805 and collection-side conduit section 807). The upward inclination angle PX3 of the lower base inclined surface 618 of the lower expanded pipe 612 with respect to the horizontal plane may be greater than or equal to 5 degrees, or may be smaller than or equal to 10 degrees. The upward inclination angle of the upper inclined surface of each partition with respect to the horizontal plane may be greater than or equal to 5 degrees, or may be smaller than or equal to 10 degrees. The inclination angle PY1 of the lower expanded pipe 612 and the upper expanded pipe 622 in the extending direction with respect to the vertical direction is, for example, greater than 0 degrees and smaller than 15 degrees.

As described above, according to the third embodiment, as in the first embodiment, pulsation of ink (liquid) supplied to the printing head 21 can be suppressed, and the installation space for the conduit sections (supply-side conduit section 805 and collection-side conduit section 807) can also be reduced.

In the first to third embodiments described above, the cross-section areas of the internal spaces of the lower through-hole portion 645, the intermediate through-hole portion 655, and the upper through-hole portion 665 are designed to be the same, but not limited thereto. For example, the cross-section areas of the internal spaces of the lower through-hole portion 645, the intermediate through-hole portion 655, and the upper through-hole portion 665 may increase toward the downstream side of the lower expanded pipe 612 and the upper expanded pipe 622. Specifically, the cross-section area of the internal space of the through-hole portion in the partition on the downstream side of the lower expanded pipe 612 and the upper expanded pipe 622 among the plurality of partitions may be larger than the cross-section area of the internal space of the through-hole portion in the partition on the upstream side of the lower expanded pipe 612 and the upper expanded pipe 622.

In the first to third embodiments described above, the lower partition 641, the intermediate partition 651, and the upper partition 661 are disposed inside the conduit section (lower expanded pipe 612 and upper expanded pipe 622), but the present disclosure is not limited thereto. For example, only one partition may be disposed inside the conduit section. Two partitions, or four or more partitions may be disposed inside the conduit section.

In the first to third embodiments described above, if each through-hole portion protrudes toward the upstream side of the lower expanded pipe 612 and the upper expanded pipe 622, the cross section of the internal space of the inlet pipe 611 as seen from the upstream side of the conduit section does not have to overlap with the cross section of the internal space of each through-hole portion. Similarly, the cross section of the internal space of each through-hole portion as seen from the upstream side of the conduit section does not have to overlap with the cross section of the internal space of the outlet pipe 621. That is, if each through-hole portion protrudes toward the upstream side of the lower expanded pipe 612 and the upper expanded pipe 622, the central axes of the inlet pipe 611, each through-hole portion, and the outlet pipe 621 do not have to be substantially aligned.

If the cross section of the internal space of the inlet pipe 611 as seen from the upstream side of the conduit section overlaps with the cross section of the internal space of each through-hole portion, and the cross section of the internal space of each through-hole portion overlaps with the cross section of the internal space of the outlet pipe 621, each through-hole portion does not have to protrude. That is, if the central axes of the inlet pipe 611, each through-hole portion, and the outlet pipe 621 are substantially aligned, each through-hole portion does not have to protrude. Furthermore, in the first embodiment described above, the first conduit section 105 and the second conduit section 106 may be disposed so that the lower flange portion 613 and the upper flange portion 623 partially overlap as seen from the upstream side of the first conduit section 105 and the second conduit section 106. In this case, the extending directions of the first conduit section 105 and the second conduit section 106 (the lower expanded pipe 612 and the upper expanded pipe 622) may be inclined relative to the vertical direction (Z direction).

### Modification

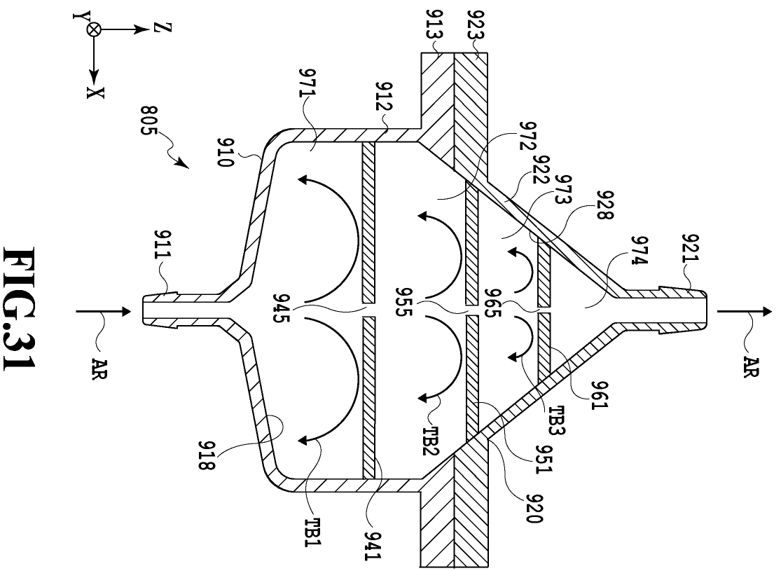

Next, a modification of the third embodiment will be described. FIG. 31 is a schematic diagram showing a supply-side conduit section 805 of the modification. Note that a collection-side conduit section 807 of the modification has the same configuration as that of the supply-side conduit section 805 of the modification. Therefore, detailed description of the collection-side conduit section 807 of the modification will be omitted.

As shown in FIG. 31, the supply-side conduit section 805 of the modification includes a lower cylinder 910, an upper cylinder 920, a lower partition 941, an intermediate partition 951, and an upper partition 961. The ink flow direction is a vertically upward direction (+Z direction). The supply-side conduit section 805 of the modification is disposed along the direction in which the ink flows from the lower side to the upper side in the vertical direction.

The lower cylinder 910 is formed in a cylindrical shape extending in the ink flow direction (Z direction). The lower cylinder 910 has an inlet pipe 911, a lower expanded pipe 912, and a lower flange portion 913. The inlet pipe 911 is formed to have the same configuration as that of the inlet pipe 611 of the first embodiment. The inlet pipe 911 is connected to the upstream side of the supply channel 200. The inlet pipe 911 allows ink flowing through the supply channel 200 to flow vertically upward. The lower expanded pipe 912 is formed on the downstream side of (above) the inlet pipe 911 in the lower cylinder 910. The cross-section area of the internal space of the lower expanded pipe 912 is larger than the cross-section area of the internal space of the inlet pipe 911. The lower flange portion 913 is formed at the upper edge of the side portion of the lower expanded pipe 912. Furthermore, on the upper surface side of the lower base of the lower expanded pipe 912 connected to the inlet pipe 911, a lower base inclined surface 918 is formed so as to be inclined downward from the side portion of the lower expanded pipe 912 toward the inlet pipe 911.

The upper cylinder 920 is formed in a conical cylindrical shape extending in the ink flow direction (Z direction). The upper cylinder 920 has an outlet pipe 921, an upper expanded pipe 922, and an upper flange portion 923. The outlet pipe 921 is formed in a tubular shape that protrudes vertically upward (+Z direction) in the upper end portion of the upper expanded pipe 922. The outlet pipe 921 is connected to the downstream side of the supply channel 200. The outlet pipe 921 allows ink flowing through the lower expanded pipe 912 and the upper expanded pipe 922 to flow out vertically upward into the supply channel 200. The upper expanded pipe 922 is formed on the upstream side of (below) the outlet pipe 921 in the upper cylinder 920. The cross-section area of the internal space of the upper expanded pipe 922 decreases toward the downstream side of the upper expanded pipe 922. The upper expanded pipe 922 has an inner peripheral surface 928 inclined upward toward the downstream side of the upper expanded pipe 922. The cross-section areas of the internal spaces of the lower expanded pipe 912 and the upper expanded pipe 922 are larger than the cross-section area of the internal space of the inlet pipe 911 and the cross-section area of the internal space of the outlet pipe 921. The cross-section area of the internal space of the outlet pipe 921 is also slightly larger than the cross-section area of the internal space of the inlet pipe 911. The upper flange portion 923 is formed on the lower edge of the side portion of the upper expanded pipe 922. The lower surface of the upper flange portion 923 abuts against the upper surface of the lower flange portion 913 of the lower cylinder 910.

The lower flange portion 913 of the lower cylinder 910 and the upper flange portion 923 of the upper cylinder 920 are joined using joining members (not shown) such as screws. The lower cylinder 910 and the upper cylinder 920 are thus joined to form the supply-side conduit section 805. As in the first embodiment, the lower flange portion 913 of the lower cylinder 910 and the upper flange portion 923 of the upper cylinder 920 may be joined using a sealing member, a lower holding plate, an upper holding plate, and the like.

Inside the supply-side conduit section 805 (lower expanded pipe 912 and upper expanded pipe 922), the lower partition 941, the intermediate partition 951, and the upper partition 961 are disposed in this order from the upstream side. The lower partition 941 is formed in a disk shape and is joined to the side portion of the lower expanded pipe 912. A first extended space 971 is formed between the lower partition 941 and the lower base of the lower expanded pipe 912. A lower through-hole portion 945 is formed in the central portion of the lower partition 941 so as to penetrate the lower partition 941. As in the first embodiment, the lower through-hole portion 945 may be formed in a cylindrical shape that protrudes toward the upstream side of the lower expanded pipe 912 and the upper expanded pipe 922.

The intermediate partition 951 is formed in a disk shape and is joined to the side portion of the upper expanded pipe 922. A second extended space 972 is formed between the intermediate partition 951 and the lower partition 941. The length of the second extended space 972 in the extending direction (Z direction) of the lower expanded pipe 912 and the upper expanded pipe 922 is shorter than the length of the first extended space 971. An intermediate through-hole portion 955 is formed in the central portion of the intermediate partition 951 so as to penetrate the intermediate partition 951. As in the first embodiment, the intermediate through-hole portion 955 may be formed in a cylindrical shape that protrudes toward the upstream side of the lower expanded pipe 912 and the upper expanded pipe 922.

The upper partition 961 is formed in a disk shape and is joined to the side portion of the upper expanded pipe 922. A third extended space 973 is formed between the upper partition 961 and the intermediate partition 951. The length of the third extended space 973 in the extending direction (Z direction) of the lower expanded pipe 912 and the upper expanded pipe 922 is shorter than the length of the second extended space 972. A fourth extended space 974 is also formed between the upper partition 961 and the upper part of the upper expanded pipe 922. The cross-section areas of the third extended space 973 and the fourth extended space 974 decrease toward the downstream side of the upper expanded pipe 922. An upper through-hole portion 965 is formed in the central portion of the upper partition 961 so as to penetrate the upper partition 961. As in the first embodiment, the upper through-hole portion 965 may be formed in a cylindrical shape that protrudes toward the upstream side of the lower expanded pipe 912 and the upper expanded pipe 922.

The lower partition 941, the intermediate partition 951, and the upper partition 961 divide the internal space of the supply-side conduit section 805 (lower expanded pipe 912 and upper expanded pipe 922), thereby forming a plurality of extended spaces aligned along the extending direction of the lower expanded pipe 912 and the upper expanded pipe 922. Specifically, the first extended space 971, the second extended space 972, the third extended space 973, and the fourth extended space 974 are formed in this order from the upstream side. The lengths of the first to third extended spaces 971 to 973 in the extending direction of the lower expanded pipe 912 and the upper expanded pipe 922 decrease toward the downstream side of the lower expanded pipe 912 and the upper expanded pipe 922.

The cross-section areas of the internal spaces of the lower through-hole portion 945, the intermediate through-hole portion 955, and the upper through-hole portion 965 may increase toward the downstream side of the lower expanded pipe 912 and the upper expanded pipe 922. The cross-section areas of the internal spaces of the lower through-hole portion 945, the intermediate through-hole portion 955, and the upper through-hole portion 965 may be designed to be the same. As shown in FIG. 31, the cross-section areas of the internal spaces of the lower through-hole portion 945, the intermediate through-hole portion 955, and the upper through-hole portion 965 may decrease toward the downstream side of the lower expanded pipe 912 and the upper expanded pipe 922.

The cross-section areas of the internal spaces of the lower through-hole portion 945, the intermediate through-hole portion 955, and the upper through-hole portion 965 may be larger than the cross-section area of the internal space of the inlet pipe 911 and smaller than the cross-section area of the internal space of the outlet pipe 921. As shown in FIG. 31, the cross-section areas of the internal spaces of the lower through-hole portion 945, the intermediate through-hole portion 955, and the upper through-hole portion 965 may be smaller than the cross-section area of the internal space of the inlet pipe 911 and the cross-section area of the internal space of the outlet pipe 921.

The inlet pipe 911, the through-hole portions (lower through-hole portion 945, intermediate through-hole portion 955, and upper through-hole portion 965) formed in the plurality of partitions, respectively, and the outlet pipe 921 are designed to be coaxially disposed. As a result, the cross section of the internal space of the inlet pipe 911 as seen from the upstream side of the supply-side conduit section 805 overlaps with the cross sections of the internal spaces of the lower through-hole portion 945, the intermediate through-hole portion 955, and the upper through-hole portion 965. The cross sections of the internal spaces of the lower through-hole portion 945, the intermediate through-hole portion 955, and the upper through-hole portion 965 as seen from the upstream side of the supply-side conduit section 805 overlap with the cross section of the internal space of the outlet pipe 921.

The ink sent through the supply channel 200 by the supply pump 801 flows into the supply-side conduit section 805 from the inlet pipe 911. Inside the supply-side conduit section 805, the ink flows into the first extended space 971 through the inlet pipe 911. The ink flowing into the first extended space 971 flows into the second extended space 972 through the first extended space 971 and the lower through-hole portion 945. The ink flowing into the second extended space 972 flows into the third extended space 973 through the second extended space 972 and the intermediate through-hole portion 955. The ink flowing into the third extended space 973 flows into the fourth extended space 974 through the third extended space 973 and the upper through-hole portion 965. The ink flowing into the fourth extended space 974 flows out to the downstream side of the supply channel 200 through the fourth extended space 974 and the outlet pipe 921.

As in the first embodiment, ink pulsation is reduced each time the ink passes through each of the extended spaces 971 to 974 and each of the through-hole portions (lower through-hole portion 945, intermediate through-hole portion 955, and upper through-hole portion 965). As the ink in the first extended space 971 passes through the lower through-hole portion 945, a relatively large first turbulence TB1 is generated in the first extended space 971. As the ink in the second extended space 972 passes through the intermediate through-hole portion 955, a second turbulence TB2 smaller than the first turbulence TB1 is generated in the second extended space 972. As the ink in the third extended space 973 passes through the upper through-hole portion 965, a third turbulence TB3 smaller than the second turbulence TB2 is generated in the third extended space 973.

In the modification of the third embodiment, the cross-section area of the internal space on the downstream side of the lower expanded pipe 912 and the upper expanded pipe 922 decreases toward the downstream side of the lower expanded pipe 912 and the upper expanded pipe 922. Furthermore, the lengths of the first to third extended spaces 971 to 973 in the extending direction of the lower expanded pipe 912 and the upper expanded pipe 922 decrease toward the downstream side of the lower expanded pipe 912 and the upper expanded pipe 922. In other words, the length of the expanded pipe (lower expanded pipe 912 and upper expanded pipe 922) in the extending direction of the expanded pipe in the extended space on the downstream side is shorter than the length of the expanded pipe in the extending direction in the extended space on the upstream side. This makes it possible to reduce the size (volume) of the extended space inside the supply-side conduit section 805 (collection-side conduit section 807) without impairing the effect of reducing the pulsation. Therefore, the supply-side conduit section 805 (collection-side conduit section 807) can be made smaller, and the installation space for the supply-side conduit section 805 (collection-side conduit section 807) can be reduced.

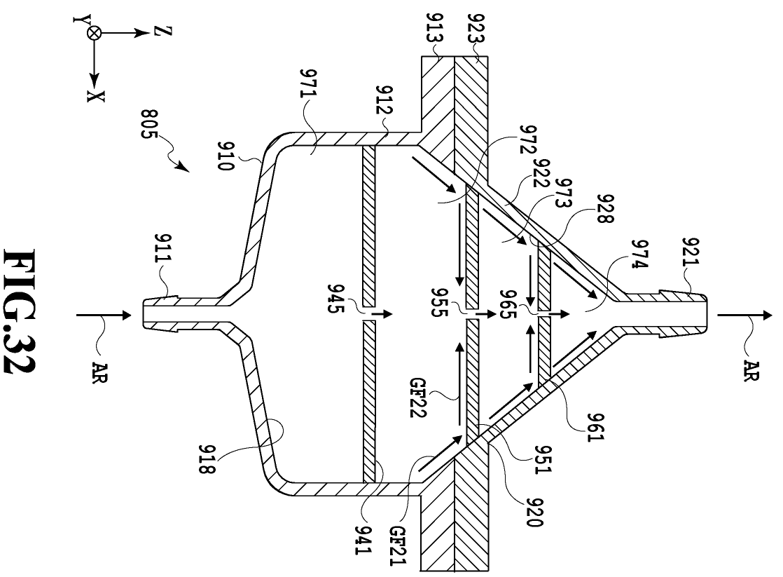

FIG. 32 is an explanatory diagram for explaining a flow of air inside the supply-side conduit section 805 of the modification. As shown in FIG. 32, the cross-section area of the internal space on the downstream side of the lower expanded pipe 912 and the upper expanded pipe 922 decreases toward the downstream side of the lower expanded pipe 912 and the upper expanded pipe 922. The air (gas) contained in the ink in the second extended space 972 and the third extended space 973 moves toward the lower surfaces of the intermediate partition 951 and the upper partition 961 along a first air flow GF21 directed obliquely upward along the inner peripheral surface 928 of the upper expanded pipe 922, for example. The air that reaches the lower surfaces of the intermediate partition 951 and the upper partition 961 moves toward the central portions of the intermediate partition 951 and the upper partition 961 along a second air flow GF22 directed inward of the lower expanded pipe 912 and the upper expanded pipe 922. The air that reaches the vicinity of the central portion of the intermediate partition 951 in the second extended space 972 moves to the third extended space 973 through the intermediate through-hole portion 955. The air that reaches the vicinity of the central portion of the upper partition 961 in the third extended space 973 moves to the fourth extended space 974 through the upper through-hole portion 965. The air contained in the ink in the fourth extended space 974 moves toward the outlet pipe 921 along the inner peripheral surface 928 of the upper expanded pipe 922 and flows out to the downstream side of the supply channel 200 through the outlet pipe 921. The air contained in the ink in each extended space of the lower expanded pipe 912 and the upper expanded pipe 922 is collected in the outlet pipe 921 and discharged to the outside of the supply-side conduit section 805. Therefore, upon execution of an ink filling operation for the printing head 21 and the circulation liquid channel, air hardly remains inside the conduit sections (supply-side conduit section 805 and collection-side conduit section 807), thus avoiding air (gas) from stagnating inside the conduit sections.

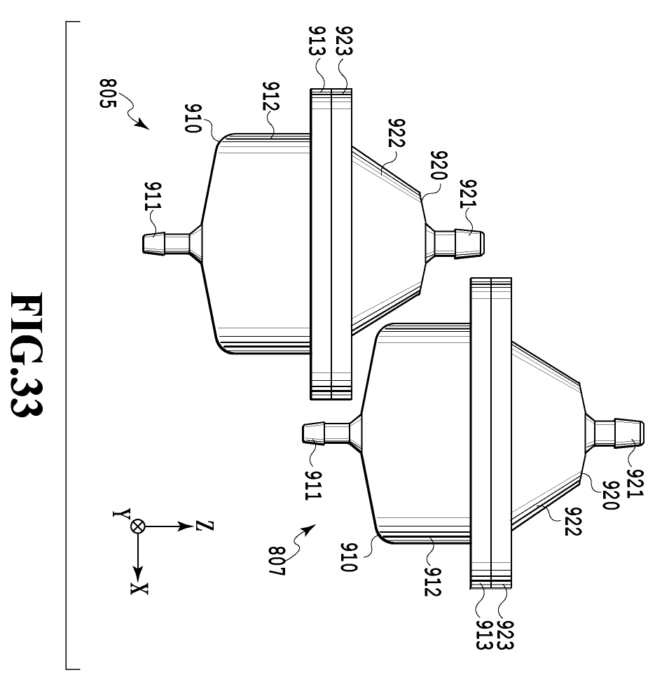

FIG. 33 is a side view of the supply-side conduit section 805 and the collection-side conduit section 807 of the modification. As shown in FIG. 33, the supply-side conduit section 805 and the collection-side conduit section 807 of the modification are provided in parallel in the circulation liquid channel (supply channel 200 and collecting channel 300). The extending direction of the supply-side conduit section 805 and the collection-side conduit section 807 (lower expanded pipe 612 and upper expanded pipe 622) of the modification is the vertical direction (Z direction). As seen from the upstream side of the supply-side conduit section 805 and the collection-side conduit section 807, the supply-side conduit section 805 and the collection-side conduit section 807 are disposed so that the lower flange portion 613 and the upper flange portion 623 partially overlap. This brings the inclined side portion of the upper expanded pipe 622 in the supply-side conduit section 805 closer to the side portion of the lower expanded pipe 912 in the collection-side conduit section 807, thus making it possible to reduce the installation space for the supply-side conduit section 805 and the collection-side conduit section 807.

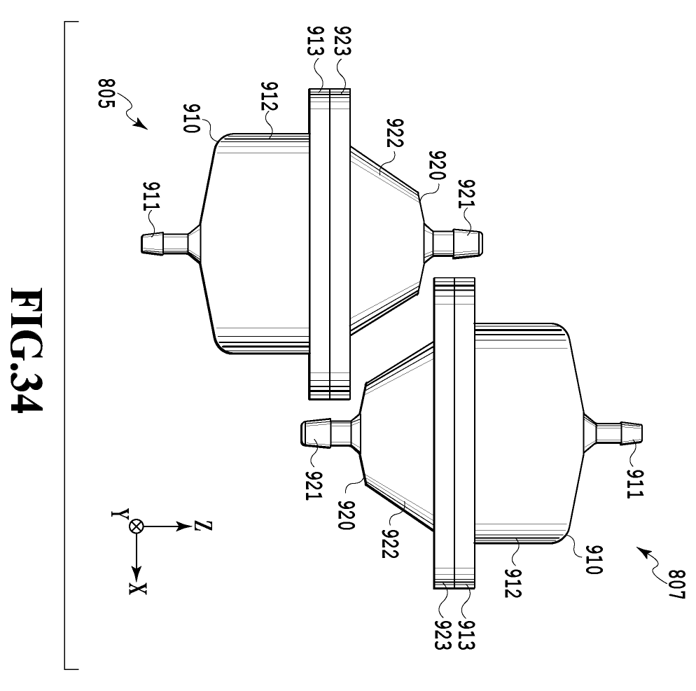

FIG. 34 is a side view of a supply-side conduit section 805 and a collection-side conduit section 807 of another modification. As shown in FIG. 34, the collection-side conduit section 807 may be upside down relative to the supply-side conduit section 805. In this case, an inclined side portion of an upper expanded pipe 622 in the supply-side conduit section 805 comes close to an inclined side portion of an upper expanded pipe 622 in the collection-side conduit section 807, thus making it possible to further reduce the installation space for the supply-side conduit section 805 and the collection-side conduit section 807.

In the above-described modification, the extending direction of the supply-side conduit section 805 and the collection-side conduit section 807 (lower expanded pipe 912 and upper expanded pipe 922) may be inclined with respect to the vertical direction (Z direction). In this case, the upward inclination angle of the inner peripheral surface 928 of the upper expanded pipe 922 with respect to the horizontal plane is preferably greater than 0 degrees. The upward inclination angle of the lower base inclined surface 918 of the lower expanded pipe 912 with respect to the horizontal plane is preferably greater than 0 degrees.

In the above-described modification, the lower partition 941, the intermediate partition 951, and the upper partition 961 are disposed inside the supply-side conduit section 805 (lower expanded pipe 912 and upper expanded pipe 922), but the present disclosure is not limited thereto. For example, only one partition may be disposed inside the supply-side conduit section 805. Two partitions or four or more partitions may also be disposed inside the supply-side conduit section 805.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

According to the present disclosure, the pulsation of the liquid supplied to the printing head can be suppressed.

What is claimed is:

1. A printing apparatus comprising:
a printing head configured to eject a liquid to print an image;
a liquid channel for supplying the liquid to the printing head;
a conduit section provided in the liquid channel;
a pump configured to send the liquid in the liquid channel through the conduit section,
wherein the conduit section includes
an inlet pipe for introducing the liquid flowing through the liquid channel,
an expanded pipe connected to a downstream side of the inlet pipe and through which the liquid flowing in from the inlet pipe flows,
an outlet pipe connected to a downstream side of the expanded pipe and through which the liquid flowing through the expanded pipe flows out to the liquid channel, and
a partition dividing an internal space of the expanded pipe along an extending direction of the expanded pipe,
wherein a cross-section area of the internal space of the expanded pipe is larger than a cross-section area of an internal space of the inlet pipe and a cross-section area of an internal space of the outlet pipe, and
wherein the partition has a through-hole portion penetrating the partition and protruding toward an upstream side of the expanded pipe.

2. The printing apparatus according to claim 1, wherein
the through-hole portion is formed in a central portion of the partition,
a cross section of the internal space of the inlet pipe as seen from an upstream side of the conduit section overlaps with a cross section of the internal space of the through-hole portion, and
the cross section of the internal space of the through-hole portion as seen from the upstream side of the conduit section overlaps with a cross section of the internal space of the outlet pipe.

3. The printing apparatus according to claim 2, wherein
the conduit section has a plurality of the partitions arranged along the extending direction of the expanded pipe,
the cross section of the internal space of the inlet pipe as seen from the upstream side of the conduit section overlaps with the cross sections of the internal spaces of the through-hole portions formed in the plurality of partitions, respectively, and
the cross sections of the internal spaces of the through-hole portions formed in the plurality of partitions, respectively, as seen from the upstream side of the conduit section overlap with the cross section of the internal space of the outlet pipe.

4. The printing apparatus according to claim 1, wherein
a cross-section area of an internal space of the through-hole portion is larger than the cross-section area of the internal space of the inlet pipe, and
the cross-section area of the internal space of the outlet pipe is larger than the cross-section area of the internal space of the through-hole portion.

5. The printing apparatus according to claim 3, wherein
cross-section areas of the internal spaces of the through-hole portions formed in the plurality of partitions, respectively, are larger than the cross-section area of the internal space of the inlet pipe, and
the cross-section area of the internal space of the outlet pipe is larger than the cross-section areas of the internal spaces of the through-hole portions formed in the plurality of partitions, respectively.

6. The printing apparatus according to claim 5, wherein
the cross-section areas of the internal spaces of the through-hole portions formed in the plurality of partitions, respectively, are substantially the same.

7. The printing apparatus according to claim 5, wherein
the cross-section area of the internal space of the through-hole portion in the partition on the downstream side of the expanded pipe, among the plurality of partitions, is larger than the cross-section area of the internal space of the through-hole portion in the partition on the upstream side of the expanded pipe.

8. The printing apparatus according to claim 1, wherein
the cross-section area of the internal space of the expanded pipe is 25 to 625 times the cross-section area of the internal space of the through-hole portion.

9. The printing apparatus according to claim 1, wherein
the extending direction of the expanded pipe is a direction along a vertical direction,
the inlet pipe is disposed below the expanded pipe and causes the liquid flowing through the liquid channel to flow in vertically upward, and
the outlet pipe is disposed above the expanded pipe and causes the liquid flowing through the expanded pipe to flow out vertically upward into the liquid channel.

10. The printing apparatus according to claim 9, wherein
the partition divides the internal space of the expanded pipe to form a plurality of extended spaces,
the through-hole portion is formed in a central portion of the partition,
a lower inclined surface is formed on a lower surface side of the partition so as to be inclined upward from the through-hole portion toward an outer periphery of the partition, and
a gap communicating with the extended spaces adjacent to each other with the partition interposed between the extended spaces is formed between the outer periphery of the partition and a side portion of the expanded pipe.

11. The printing apparatus according to claim 10, wherein
a width of the gap is smaller than or equal to an inner width of the through-hole portion.

12. The printing apparatus according to claim 10, wherein
an upper base inclined surface is formed on a lower surface side of an upper base of the expanded pipe connected to the outlet pipe so as to be inclined upward from the side portion of the expanded pipe toward the outlet pipe.

13. The printing apparatus according to claim 12, wherein
the outlet pipe is disposed in a central portion of the upper base of the expanded pipe.

14. The printing apparatus according to claim 9, wherein
the through-hole portion is formed in the central portion of the partition, and
an upper inclined surface is formed on an upper surface side of the partition so as to be inclined downward from an outer periphery of the partition toward the through-hole portion.

15. The printing apparatus according to claim 14, wherein
a lower base inclined surface is formed on an upper surface side of a lower base of the expanded pipe connected to the inlet pipe so as to be inclined downward from a side portion of the expanded pipe toward the inlet pipe.

16. The printing apparatus according to claim 15, wherein
the inlet pipe is disposed in a central portion of the lower base of the expanded pipe.

17. The printing apparatus according to claim 1, further comprising:
a solenoid valve provided in a portion of the liquid channel between the conduit section and the printing head;
a negative pressure applying unit configured to apply negative pressure to the liquid channel through the printing head; and
a control unit configured to control a filling operation for filling the printing head and the liquid channel with the liquid, wherein
the pump sends the liquid in the liquid channel to the printing head through the conduit section, and
during the filling operation, the control unit controls the solenoid valve to close the liquid channel and also controls the solenoid valve to open the liquid channel with the negative pressure applied in the liquid channel by the negative pressure applying unit, thereby allowing the liquid to flow through the liquid channel.

18. The printing apparatus according to claim 1, wherein
the pump sends the liquid in the liquid channel to the printing head through the conduit section, and
a distance between the pump and the conduit section in the liquid channel is shorter than a distance between the conduit section in the liquid channel and the printing head.

19. The printing apparatus according to claim 18, wherein
the liquid channel has a plurality of branching flow passages configured to branch off and merge midway through the liquid channel,
the pump and the conduit section are provided in each of the plurality of branching flow passages,
a junction of the plurality of branching flow passages is disposed between the printing head and the plurality of branching flow passages in the liquid channel, and
the conduit section is disposed between the pump and the junction in the branching flow passage.

20. The printing apparatus according to claim 1, further comprising:
a holding member configured to hold the conduit section; and
a fixing member configured to fix the conduit section to the holding member, wherein
the pump sends the liquid in the liquid channel to the printing head through the conduit section,
the partition divides the internal space of the expanded pipe to form a plurality of extended spaces, and
the fixing member fixes a portion of the conduit section, in which the extended space on the most upstream side in the expanded pipe is located, to the holding member.
